(19) United States
(12) Patent Application Publication
(10) Pub. No.: US 2012/0051199 A1
(43) Pub. Date: Mar. 1, 2012

(54) OPTICAL DISK DEVICE AND TRACK PULL-IN METHOD

(76) Inventor: Shinsuke Onoe, Fujisawa (JP)

(21) Appl. No.: 13/195,616

(22) Filed: Aug. 1, 2011

(30) Foreign Application Priority Data
Sep. 1, 2010 (JP) 2010-195281

(51) Int. Cl. G11B 7/09

(52) U.S. Cl. 369/47.44; G9B/7.066; G9B/7.073

(57) ABSTRACT

To improve the track pull-in performance in the servo control of an optical disk device, track pull-in is performed by driving the objective lens by an actuator, outputting an electrical signal according to the amount of reflected light from the optical disk, generating a focus error signal and a tracking error signal from the output electrical signal, outputting a focus control signal based on the focus error signal to drive the actuator in the rotation axis direction, outputting a tacking control signal based on the tracking error signal to drive the actuator in the radial direction of the optical disk, controlling the speed of the actuator so that the cycle of the tracking error signal is kept substantially constant, moving the objective lens in the radial direction before the start of the speed control, and supplying the tracking control signal to the actuator after the start of the speed control.

### INCORPORATION BY REFERENCE

This application relates to and claims priority from Japanese Patent Application No. 2010-195281 filed on Sep. 1, 2010, the entire disclosure of which is incorporated herein by reference.

### BACKGROUND OF THE INVENTION

(1) Field of the Invention

The present invention relates to an optical disk device.

(2) Description of the Related Art

In general, an optical disk rotates with an eccentricity in an optical disk drive. The optical disk drive performs control such as seek and track pull-in for the optical disk with the eccentricity.

Here, the track pull-in performance is degraded in an optical disk with a large eccentricity.

According to Japanese Patent Application Laid-Open No. 2005-216441 in paragraph 0005, it is described that “Tracking pull-in of an optical pick up is performed by the steps of: at the time when an optical disk is loaded into a disk device, detecting an FG signal generated by the rotation of a spindle motor for rotating the optical disk, to detect the rotation angle of the optical disk; measuring the track cross signal for the detected rotation angle of the optical disk; detecting the amplitude and cycle of the eccentricity of the optical disk with respect to the rotation angle of the optical disk, based on the measured track cross signal for the rotation angle of the optical disk; storing the amplitude and cycle of the eccentricity of the optical disk with respect to the detected rotation angle of the optical disk; when reproducing the optical disk, synchronizing with the amplitude and cycle of the eccentricity of the optical disk with respect to the stored rotation angle of the optical disk; moving the optical pickup back and forth in the radial direction of the optical disk; and controlling the tracking of the optical pickup”.

According to Japanese Patent Application Laid-Open No. 2003-196849 in paragraph 0010, it is described that “Tracking pull-in is performed by detecting the relative speed between the moving speed in the track direction of the disk to be pulled in, and the moving speed of the optical pickup, and by controlling the polarity of the actuator drive voltage supplied to the tracking actuator, as well as the voltage value thereof, according to the detected relative speed”.

According to Japanese Patent Application Laid-Open No. 2007-35080 in paragraph 0014, it is described that “The configuration includes: speed detection means for detecting the moving speed of the objective lens; kick means for providing a kick pulse signal to the tracking actuator; sliding direction detection means for detecting the moving direction of the track with respect to the objective lens, after the kick means is operated; constant speed control means for driving the tracking actuator according to the output of the speed detection means to make the moving speed of the objective lens substantially constant, in the same direction as the sliding direction detected by the sliding direction detection means; and tracking servo pull-in means for operating the tracking control means after the constant speed control means is operated”. Further, it is also described in paragraph 0056 that “During such a kick operation, a difference value by subtracting the last measured cycle of the count signal COUT (the output of a delay circuit 14) from the currently measured cycle of the count signal COUT (the output of a frequency detection circuit 13) is obtained by a sliding direction detection circuit 16. At the time of a kick in the outer peripheral direction, when the difference value obtained by the sliding direction detection circuit 16 is positive, the track runs in the outer peripheral direction with respect to an objective lens 3a. When the difference value obtained by the sliding direction detection circuit 16 is negative, the track runs in the inner peripheral direction. In this way, the running direction is detected, and the running direction of the track is determined”.

Further, according to Japanese Patent Application Laid-Open No. 2003-203363 in paragraph 0008, it is described that “The actuator sensitivity of a lens 2 varies by lens shift”. It is also described in paragraph 0016 that “The switch means is controlled so as to gradually perform switching between the position control means and the speed control means”.

### SUMMARY OF THE INVENTION

In general, in optical disks such as Blu-ray and DVD, the amount of eccentricity allowable for each optical disk is defined by a standard. However, there is an optical disk with an eccentricity greater than that defined by the standard, due to the displacement of the position of the center hole in the optical disk. Further, there is a displacement of a turntable for chucking the optical disk in an optical disk drive. In the control by the optical disk drive, the eccentricity is determined by the following factors: the displacement of the center hole in the optical disk from the rotation axis center of a spindle motor, and the displacement of the turntable. At this time, the direction of the displacement of the center hole and the direction of the displacement of the turntable are changed according to the chucking state of the optical disk. So the eccentricity changes. In the optical disk drive, various performances must be achieved even in the chucking state with the maximum possible eccentricity.

Next, a tracking error signal will be described. The tracking error signal (hereinafter referred to as TE signal) is an error signal used for the tracking control in the optical disk device.

FIG. 20 shows the TE signal, in which the position of the objective lens in the radial direction of the disk, is fixed at an arbitrary position from the state in which the focus control is constantly operated, and the optical disk with an eccentricity is rotated.

FIG. 20(b) shows the TE signal obtained when the focal point of a laser beam passes across the track as shown in FIG. 20(a). Points A to J in FIG. 20(b) correspond to each of the points shown in FIG. 20(a).

In FIG. 20(a), the dotted line is the track of the optical disk. The track is formed in a spiral manner. The center point of the spiral track is denoted by O, while the rotation point is denoted by O′. As shown in FIG. 20(a), it is considered the case in which the positions of O and O′ are displaced from each other. The distance ECC between O and O′ is hereinafter referred to as eccentricity. When the eccentricity is present, the trajectory of the focal point of the laser beam is as shown by the solid line.

Because the center point O and the rotation center O′ are displaced in the spiral track, the focal point of the laser beam, which has been positioned at point A, passes across the center of the track at each of the positions B to J along with the rotation of the optical disk. Note that for the purpose of explanation, the point A is defined as the point on the extended line in the direction of the displacement between O and O′ (the vertical direction in FIG. 20(a)). Further, the point K shows the intersection of the two intersections between the extended line and the laser beam trajectory, other than the point A.

In FIG. 20(b), the time indicated by Tᵣₒₜ is the rotation cycle. As can be seen from the figure, the TE signal repeats thin and dense for every half cycle. The TE signal is thin at the time when the eccentricity is the minimum value (the point A in FIG. 20(a)) and at the time when the eccentricity is the maximum value (the point K in FIG. 20(a)). Further, as can be seen from FIGS. 20(a) and (b), the number of times the TE signal crosses zero in one cycle is proportional to the eccentricity ECC.

Further, when the eccentricity, which is the change in the displacement of the track viewed from the track, is plotted, the result is shown in FIG. 20(c). The eccentricity is represented by a sine wave that changes in the same cycle as the rotation cycle. The amplitude of the sine wave is equal to the eccentricity ECC.

At this time, when the moving speed of the track viewed from the objective lens is plotted, the result is shown in FIG. 20(d). That is, when an eccentricity waveform y is given by the following equation using a rotation frequency fᵣₒₜ and a predetermined phase φ

y=ECC·sin(2πfᵣₒₜt+φ) Equation (1)

the speed is calculated by differentiating the position, so that a speed v is expressed as

ν=dy/dt=2πfᵣₒₜ·ECC·sin(2πfᵣₒₜt+φ) Equation (2)

As described above, the speed of the track is zero at the point where the eccentricity is the maximum value and the point where the eccentricity is the minimum value. The speed of the track reaches a peak between the points where the eccentricity is the maximum and minimum values. The difference between the two speeds of the track appears as thin and dense in the TE signal.

As described above, the positive and negative of the speed are reversed at the points where the eccentricity is the maximum and minimum values. This phenomenon is hereinafter referred to as eccentricity fold. The point is the same as the point where the TE signal is thin.

Further, as can be seen from the equation (2), the peak value of the speed is proportional to the eccentricity ECC. In other words, a peak value Vmax of the speed in FIG. 20(d) is proportional to the eccentricity ECC.

FIG. 20(e) shows the TE signal when the optical disk has a larger eccentricity. In the case of the optical disk with a large eccentricity, the number of times the TE signal crosses zero increases in the same period of the rotation cycle Tᵣₒₜ. As a result, the zero crossing of the TE signal at the time when the TE signal is dense increases as the eccentricity ECC becomes larger.

In general, track pull-in is the process of pulling in the track by monitoring the cycle of the TE signal, and turning on the tracking servo after detecting that the cycle of the TE signal is longer than a predetermined time width. In other words, the track pull-in is performed after waiting until the cycle of track crossing is thin in the TE signal that repeats thin and dense.

The reason is that the bandwidth of the tracking servo is limited. That is, when the frequency of the track crossing is higher than the bandwidth of the servo, stable track pull-in may not be achieved and the track pull-in process will fail. Thus, in order not to perform track pull-in at the time when the frequency of the track crossing is higher than the bandwidth of the servo, the process waits for the track-crossing to be thin.

Meanwhile, it is generally known that in the optical pickup of the optical disk device, the gain of the tracking servo is reduced by lens shift. In the present specification, this phenomenon is referred to as visual field characteristics. FIG. 21 is a view of an example of the relationship between the amount of lens shift and the amount of reduction in the gain of the tracking servo. Here, the reduction in the gain of the tracking servo is −2 dB when the same lens shift as the eccentricity ECC is applied. While the reduction in the gain of the tracking servo is −6 dB when the lens shift twice the eccentricity ECC is applied.

Here, the lens shift immediately after the track pull-in using a conventional method will be described with reference to FIG. 22. FIG. 22 shows waveform diagrams illustrating the transition of the lens shift after track pull-in.

FIG. 22 (a) shows the eccentricity, (b) shows the TE signal, and (c) shows the lens shift, (d) and (e) show the signals for explanations, (d) shows the signal set to a high level when the tracking servo is driven, and (e) shows the signal set to a high level when the slider is driven.

Time t=t_TrON represents the time when the tracking servo is turned on, which is the time when the zero crossing of the TE signal is thin in FIG. 22(b). The time when the zero crossing of the TE signal is thin is the same as the time when the eccentricity is the maximum value or the minimum value. In FIG. 22(a), time t=t_TrON is the same as the time when the eccentricity is the maximum value.

After the track pull-in is successful, the objective lens then follows the pulled-in track along the eccentricity shown in FIG. 22(a). Thus, in the lens shift waveform shown in FIG. 22(c), a lens shift twice the eccentricity ECC occurs (indicated by the arrow marked A).

Time t=SldON indicates the time when the slider drive output is started after the track pull-in. Here, it is assumed that time t=SldON is the time after a half rotation cycle from time t=t_TrON.

In general, the slider drive uses the signal obtained by averaging the signal in a servo loop with the tracking servo turned ON, during a half rotation cycle or more. This is to equalize the influence of eccentricity elements. Thus, in the operation shown in FIG. 22 to start the slider drive after a half rotation cycle from the track pull-in, the slider is started as early as possible.

When a predetermined period of time (a half rotation cycle in FIG. 22) has elapsed after the track pull-in, the slider is started to be driven (t=t_SldON). Then, when a sufficient time has elapsed, the objective lens moves around the position where the lens shift is zero. The state in which a sufficient time has elapsed after the slider drive output is started, is referred to as the slider steady state.

As can be seen from FIG. 22, the lens shift in the slider steady state is in the range of ±ECC (indicated by the arrow marked B). Thus, in the case of the conventional track pull-in method, the lens shift increases beyond the range of ±ECC which is the value of the lens shift in the slider steady state, until the slider is driven after the track pull-in.

Here, in the case of the optical disk device having the visual filed characteristics shown in FIG. 21, the reduction in the gain of the tracking servo is −6 dB at the time when the lens shift is twice the eccentricity ECC. This means that the gain of the tracking servo is reduced by 6 dB.

The reduction in the gain of the tracking servo leads to the reduction in the tracking performance. In the worst case, off-track may occur and the track pull-in will fail.

Even if such an off-track does not occur, the suppression of eccentricity and track distortion decreases due to the reduction in the gain of the tracking servo. Thus, the residual error increases. As a result, the amplitude of the eccentricity or the track distortion component in the TE signal is increased. In general, track pull-in determination is performed in the track pull-in process after the tracking servo is turned on. This is to determine whether the track pull-in is successful or not. For example, there is a method of monitoring the level of the TE signal to determine the result of the track pull-in. However, a large residual error means that the objective lens is not on the track. Thus, the larger the residual error immediately after the track pull-in, the higher the possibility that the track pull-in determination is incorrect, whatever may be the method of determining the track pull-in. As a result, the track pull-in process fails.

The problem of the tracking gain reduction immediately after the track pull-in, can be solved if the track pull-in can be performed at the time when the lens sift is zero. In other words, it is when the track crossing is dense. The larger the eccentricity of the optical disk the higher the zero-crossing frequency of the TE signal at the time when the TE signal is dense. So the frequency of the TE signal moves away from the servo response frequency. As a result, the track may not be able to be pulled in.

Accordingly, a first problem to be solved by the present invention is the degradation of the tracking performance because the lens shift temporarily increases immediately after track pull-in.

Further, in the case of track pull-in in the conventional method, as can be seen from FIG. 22(c), the lens shift is zero before the start of the track pull-in. In other words, in the state in which the objective lens is stable, the tracking servo is turned on to perform the track pull-in. Meanwhile, the track has an eccentricity and is seen moving when viewed from the objective lens. Thus, in the state in which the speed of the objective lens is zero, the tracking servo is turned on to start control to follow the moving track. If the relative speed can be reduced at the time when the tracking servo is turned on, it is possible to increase the track pull-in performance.

This problem is particularly important with the optical disk having a large eccentricity. In other words, as can be seen from the comparison between FIGS. 20(b) and (e), when comparing the frequencies of the TE signal at the time when the track crossing is thin, the frequency of the TE signal is higher in (e) with a large eccentricity. As the servo response frequency is constant regardless of the eccentricity, the greater the eccentricity the higher the frequency of the track at the time of the track pull-in. So the frequency is not likely to be suppressed. For this reason, the track pull-in performance is easily degraded due to the disturbance such as track distortion or when the control of the servo gain varies.

Accordingly, a second problem to be solved by the present invention is the track pull-in performance degradation due to the difference in the speed between the track and the objective lens at the time when the tracking servo is turned on.

The above description of the first and second problems uses the phrase “track pull-in performance degradation”. In the first problem, the track pull-in performance degradation means that an off track occurs in the first following operation although the tracking servo is once turned on and then the laser spot starts following the track, or that the track pull-in determination has been determined incorrectly and the track pull-in process failed. While in the second problem, the track pull-in performance degradation means that the laser spot may not be able to follow the track at the time when the tracking servo is turned on.

Although there is a difference in the details of the phenomenon described as “the track pull-in performance degradation” in each of the problems, both are the same in the fact that the track pull-in process results in a failure. For this reason, the common expression of “the track pull-in performance degradation” is used in this specification.

Japanese Patent Application Laid-Open No. 2005-216441 (the first patent document) discloses a method of improving the track pull-in performance by adding the eccentricity that has been learned, to the tracking dive output, in order to reduce the relative displacement between the objective lens and the track. This method will not be able to solve the first problem. From the point of view of the fact that the relative displacement between the objective lens and the track is reduced, the track pull-in performance is improved. However, it is designed to start the control of following the moving track from the state in which the initial speed is zero. So also the second problem is not solved.

Japanese Patent Application Laid-Open No. 2003-196849 (the second patent document) discloses a method of performing track pull-in after controlling to keep the relative speed between the objective lens and the track substantially constant. This method does not take into account the first problem, and starts controlling the relative speed to be kept substantially constant from the state in which the lens shift is zero. The lens moves from the initial position during the period until the relative speed is substantially constant, and reaches the lens shift state at the time of the track pull-in. Thus, the first problem may not be able to be solved.

Japanese Patent Application Laid-Open No. 2003-35080 (the third patent document) discloses a method of performing track pull-in, by starting the movement of the objective lens from the state in which the lens shift is zero due to the acceleration by kick means, and then by controlling the relative speed between the objective lens and the track to be kept substantially constant. The purpose of the kick means is to detect the moving direction of the track, from the change in the track crossing frequency by the kick (acceleration). However, also in this method, the lens moves from the initial position during the period until the relative speed is substantially constant, and reaches the lens shift state at the time of the track pull-in. Thus, the first problem may not be able to be solved.

Japanese Patent Application Laid-Open No. 2003-203363 (the fourth patent document) discloses a method of reducing the time until the speed control is stabilized, by performing position control in rough seek mode to gradually switch the speed control, in order to suppress the lens vibration at the time of the speed control switching. When comparing this patent document with the second patent document, the disclosed methods are the same in that the track pull-in is performed after the speed control is performed. However, there is a difference in that the second patent document performs the speed control in the sole track pull-in operation, while the fourth patent document performs the speed control in the track pull-in at the end of rough seek mode. In the case of the track pull-in in the rough seek mode, stabilization of the speed control requires more time than in the sole track pull-in operation, due to the vibration of the lens in the switching between the position control and the speed control. As a result, the lens shift is greater than that in the case of performing the speed control at the time of the track pull-in. For this reason, in the fourth patent document, the position control and the speed control are gradually switched. The effect of reducing the time until the speed control is stabilized by this method, is equal to the elapsed time of the lens vibration state in the switching between the position control and the speed control. In other words, also in the fourth patent document, similarly to the second patent document, the lens continues to be shifted until the relative speed is substantially constant. Thus, the lens is shifted at the time of track pull-in. In the fourth patent document, the time for stabilizing the speed control is reduced by taking into account the visual filed characteristics. However, the present inventors consider that the lens shift in the speed control in the sole track pull-in operation is also a problem. Thus, further improvement of the track pull-in performance is desired.

From the point of view of the pickup design, the view field characteristics in the lens shift twice the eccentricity ECC must also be taken into account, in order to support the optical disk with the eccentricity ECC. Thus, there is a problem that the pickup design is limited such that the size reduction by using an objective lens with a small lens diameter is not allowed.

It is desirable to improve the track pull-in performance in an optical disk device.

In order to improve the track pull-in performance, the present invention uses, as an example, the configurations described in the scope of claims.

According to the present invention, it is possible to improve the track pull-in performance in the optical disk device.

### BRIEF DESCRIPTION OF THE DRAWINGS

These and other features, objects and advantages of the present invention will become more apparent from the following description when taken in conjunction with the accompanying drawings wherein:

FIG. 1 is a block diagram of a first embodiment;

FIG. 2 is a block diagram of a servo control signal generation circuit according to the first embodiment;

FIG. 3 shows waveform diagrams illustrating signals output from a MIRR signal generation circuit and a TZC signal generation circuit in the first embodiment;

FIG. 4 is a block diagram of a speed control circuit of the first embodiment;

FIG. 5 is a block diagram of a lens shift voltage output circuit of the first embodiment;

FIG. 6 shows waveform diagrams illustrating the operation of the lens shift voltage output circuit in the first embodiment;

FIG. 7 is a flow chart of a track pull-in process in the first embodiment;

FIG. 8 shows waveform diagrams illustrating the operation when track pull-in process is performed in the first embodiment;

FIG. 9 shows waveform diagrams illustrating the effect of the first embodiment;

FIG. 10 is a block diagram of a second embodiment;

FIG. 11 is a block diagram of a speed control circuit of the second embodiment;

FIG. 12 is a flow chart of a track pull-in process in the second embodiment;

FIG. 13 is a view of a retry alignment in the second embodiment;

FIG. 14 shows waveform diagrams illustrating the effect of the second embodiment;

FIG. 15 is a block diagram of a third embodiment;

FIG. 16 is a block diagram of a servo control signal generation circuit of the third embodiment;

FIG. 17 is a block diagram of a speed control circuit of the third embodiment;

FIG. 18 is a flow chart of a track pull-in process in the third embodiment;

FIG. 19 shows waveform diagram illustrating the effect of the third embodiment;

FIG. 20 shows schematic diagrams illustrating the TE signal when an optical disk with an eccentricity is rotated;

FIG. 21 is a diagram illustrating the visual field characteristics; and

FIG. 22 shows waveform diagrams illustrating the problem to be solved.

### DETAILED DESCRIPTION OF THE EMBODIMENTS

Hereinafter, preferred embodiments of the present invention will be described with reference to the accompanying drawings.

### First Embodiment

Hereinafter a first embodiment according to the present invention will be described.

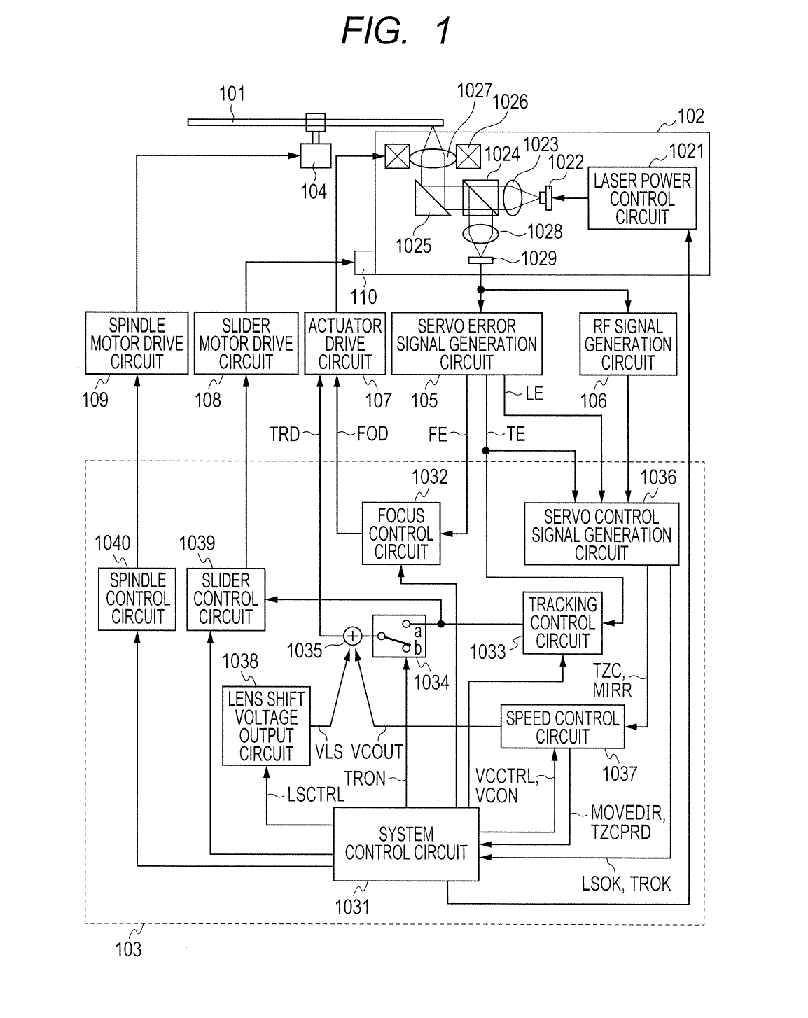

FIG. 1 is a block diagram showing the configuration of an optical disk device according to the first embodiment.

A signal processing circuit 103 is a circuit for performing various signal processes of the optical disk device.

The signal processing circuit 103 operates based on a reference voltage Vref.

An optical disk 101 is rotated at a predetermined rotation speed. At this time, a spindle motor 104 is driven by a spindle motor drive circuit 109, based on a control signal output from a spindle control circuit 1040 in response to a command signal received from a system control circuit 1031. The system control circuit 1031 is provided in the signal processing circuit 103.

A laser light source 1022 emits a laser beam with a predetermined power, in response to a command signal from the system control circuit 1031 to a laser power control circuit 1021 provided in a pickup 102. The laser beam emitted from the laser light source 1022 is focused as a light spot on the information recording surface of the optical disk 101, through a collimating lens 1023, a beam splitter 1024, a vertical mirror 1025, and an objective lens 1027. The light reflected from the information recording surface of the optical disk 101 is split by the beam splitter 1024, and is focused to an optical detector 1029 by a focusing lens 1028. The optical detector 1029 converts the focused light into an electrical signal, and outputs the electrical signal to a servo error signal generation circuit 105 and to an RF signal generation circuit 106.

The servo error signal generation circuit 105 generates and outputs a focus error signal FE used for focus control, a tracking error signal TE used for tracking control, and a lens error signal LE indicating the displacement (lens shift) of the objective lens 1027 from the neutral position. In this embodiment, it is assumed that the polarity of the LE signal shows a positive voltage when the objective lens 1027 is shifted to the outer peripheral side, while showing a negative voltage when the objective lens 1027 is shifted to the inner peripheral side. It is also assumed that the individual error signals are output based on the reference voltage Vref.

The RF signal generation circuit 106 outputs an RF signal by applying an equalization process to the electrical signal detected by the optical detector 1029.

The focus control circuit 1032 outputs a focus drive signal FOD based on a focus error signal FE in response to a command signal from the system control circuit 1031.

The actuator drive circuit 107 drives the actuator 1026 that is configured to operate with the objective lens 1027 according to the focus drive signal FOD, in the direction perpendicular to the disk surface. As described above, with the operation of the focus control circuit 1032 and the actuator drive circuit 107, the focus control is performed to allow the light spot irradiated on the optical disk 101 to be constantly focused on the information recording surface of the optical disk 101.

When the focus control is operated and the light spot is focused on the information recording surface of the optical disk 101, the servo error signal generation circuit 105 outputs the tracking error signal TE indicating the displacement of the positions between the light spot and the track on the information recording surface. Further, the servo error signal generation circuit 105 outputs the LE signal indicating the lens shift of the objective lens 1027.

The tracking control circuit 1033 outputs a signal to drive the objective lens 1027 in the radial direction of the disk, so that the light spot irradiated on the optical disk 101 follows the track on the information recording surface, based on the tracking error signal TE in response to a command signal from the system control circuit 1031. The signal output from the tracking control circuit 1033 is input to the actuator drive circuit 107 as a tracking drive signal TRD, through a switch 1034 and an adder 1035.

The switch 1034 selects the output signal from the tracking control circuit 1033, or selects the reference voltage Vref, based on the TRON signal output from the system control circuit 1031. Then, the switch 1034 outputs the selected signal. When a high level is input as the TRON signal, the switch 1034 selects a terminal a, and outputs the output signal of the tracking control circuit 1033 to the actuator. On the other hand, when a low level is input as the TRON signal, the switch 1034 selects a terminal b, and outputs the reference voltage Vref.

As a result, the TRON signal is used to indicate whether the tracking servo is turned on or off. The switch 1034 functions as a switch for switching ON/OFF of the tracking servo. When the TRON signal is switched from low to high, the output signal of the tracking control circuit 1033 is supplied to the actuator through the switch 1034. In this way, the tracking servo is turned on. This operation is called the track pull-in operation.

The adder 1035 adds the output signal of the switch 1034, VCOUT signal output from the speed control circuit 1037 that will be described below, and VLS signal output of the lens shift voltage output circuit 1038 that will be described below. Then, the adder 1035 outputs the added signal as a tracking drive signal TRD.

The actuator drive circuit 107 drives the actuator 1026 in the direction parallel to the disk surface, according to the tracking drive signal TRD. In this way, the objective lens 1027 is driven in the radial direction of the disk. By driving the actuator based on the output signal from the tracking control circuit 1033, the light spot follows the track on the information recording surface. As described above, the actuator drive circuit 107 according to this embodiment includes the circuit for driving in the focus direction, and the circuit for driving in the tracking direction.

The servo control signal generation circuit 1036 generates various control signals, based on the input of the TE signal and LE signal output from the servo error signal generation circuit 105, as well as the RF signal output from the RF signal generation circuit 106. The servo control signal generation circuit 1036 according to this embodiment generates and outputs MIRR signal, TZC signal, TROK signal, and LSOK signal. Of these signals, the TROK signal and the LSOK signal are output to the system control circuit 1031.

The speed control circuit 1037 outputs the signal VCOUT for driving the actuator to perform speed control, based on the TZC signal and MIRR signal output from the servo control signal generation circuit 1036. At the time of the speed control, the parameters for the speed control are set according to the signal VCCTRL output from the system control circuit 1031. Further, the ON/OFF of the speed control output is controlled by the signal VCON output from the system control circuit 1031.

The lens shift voltage output circuit 1038 outputs the voltage as VLS signal to shift the objective lens 1027 in the radial direction, based on LSCTRL signal output from the system control circuit 1031.

The slider control circuit 1039 receives a command signal from the system control circuit 1031, and outputs a slider drive signal for driving a slider motor 110 based on the average value of the output signal of the tracking control circuit 1033. The slider motor drive circuit 108 drives the slider motor 110 according to the slider drive signal. Thus, the optical pickup 102 is moved in the radial direction of the disk so that the objective lens 1027 is typically operated in the vicinity of the neutral position where the lens shift is zero, even if the light spot continues to follow the track.

Further, in the seek operation for driving the optical pickup 102 to positions at different radii on the optical disk 101, the slider control circuit 1039 outputs a slider drive signal in response to a command signal for the seek operation from the system control circuit 1031. Then, the slider motor drive circuit 108 drives the slider motor 110 according to the slider drive signal. In this way, the seek operation is performed.

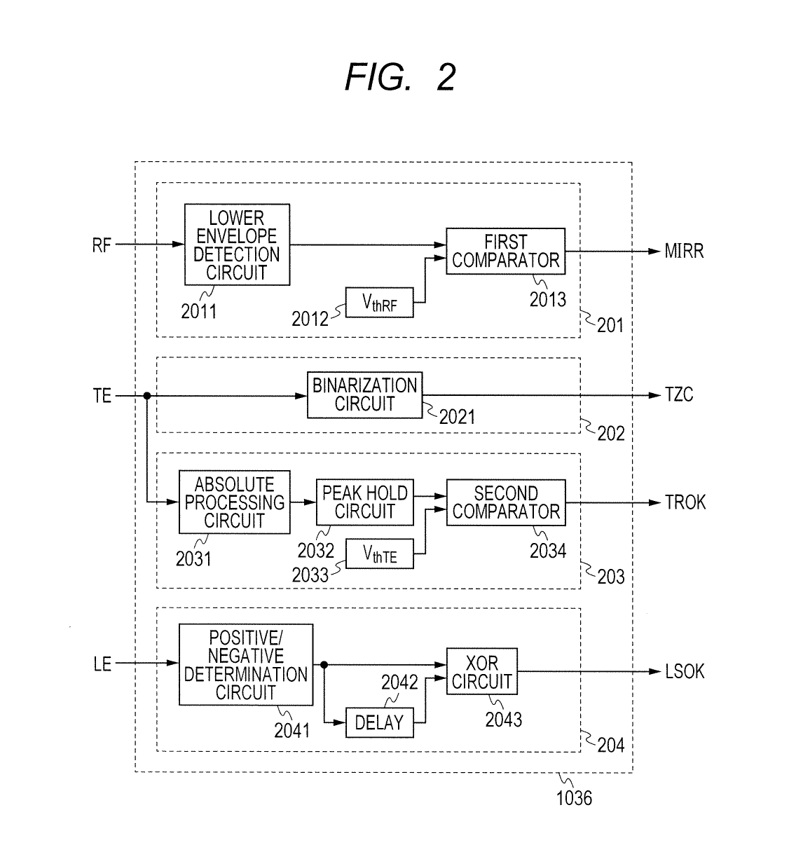

Next, the configuration of the servo control signal generation circuit 1036 of such an optical disk device will be described with reference to FIG. 2.

The servo control signal generation circuit 1036 generates and outputs MIRR signal, TZC signal, TROK signal, and LSOK signal, based on the input of the RF signal, TE signal, and LE signal. The servo control signal generation circuit 1036 includes MIRR signal generation circuit 201, TZC signal generation circuit 202, TROK signal generation circuit 203, and LSOK signal generation circuit 204.

The MIRR signal generation circuit 201 includes a lower envelope detection circuit 2011, a first threshold voltage output circuit 2012, and a first comparator 2013.

The lower envelope detection circuit 2011 outputs the level of the lower envelope of the RF signal.

The first threshold voltage output circuit 2012 outputs a predetermined voltage level VthRF.

The first comparator 2013 determines whether the output signal of the lower envelope detection circuit 2011 is greater than the voltage level VthRF output from the first threshold voltage output circuit 2011. Then, the first comparator 2013 generates a high or low logic signal according to the result of the determination, and outputs as MIRR signal.

The TZC signal generation circuit 202 is a binarization circuit 2021 based on the input of the TE signal. The binarization circuit 2021 generates a signal by binarizing the TE signal based on the reference voltage Vref, and outputs as TZC signal.

The TROK signal generation circuit 203 includes an absolute processing circuit 2031, a peak hold circuit 2032, a second threshold voltage output circuit 2033, and a second comparator 2034.

The absolute processing circuit 2031 takes the absolute value of the TE signal, and outputs the absolute value. At this time, the absolute value of the TE signal means the absolute value of the TE signal based on Vref.

The peak hold circuit 2032 monitors the output signal of the absolute processing circuit 2031 during a predetermined time Tw_TRON. The peak hold circuit 2032 holds and outputs the peak value.

The second threshold voltage output circuit 2033 outputs a predetermined voltage level VthTE.

The second comparator 2034 determines whether the output signal of the peak hold circuit 2032 is greater than the voltage level VthTE output from the second threshold voltage output circuit 2033. Then, the second comparator 2034 generates a high or low logic signal according to the result of the determination, and outputs as TROK signal.

The TROK signal is high, when peak hold circuit 2032 monitors the maximum value of the TE signal amplitude in the predetermined time Tw_TRON and when the second comparator 2034 determines that the value is greater than the threshold. When the time Tw_TRON for monitoring in the peak hold circuit 2032 is longer than the track crossing cycle, the output signal of the peak hold circuit 2032 is the TE amplitude at the time when the tracking servo is turned off. By taking advantage of this fact, the TROK signal can be used as a signal to determine whether the tracking pull-in is achieved.

In other words, when the tracking pull-in is not successful, the output signal of the peak hold circuit 2032 is the TE amplitude at the time when the tracking servo is turned off. On the other hand, when the track pull-in is successful, the TE signal is a value in the vicinity of Vref. So the output signal of the peak hold circuit 2032 is a value smaller than the TE amplitude. Thus, the TROK signal can be used for determining success or failure of the track pull-in process, by appropriately setting the monitoring period Tw_TRON and the voltage level VthTE.

Note that as the peak hold circuit 2032 holds the peak value, even if the track pull-in has been successful, the TROK signal is temporarily low when the light spot passes through a defect in the following operation. Thus, in the track pull-in determination process, for example, the TROK signal is monitored for a predetermined period, and if the TROK signal is high in the predetermined period, it is possible to determine that the track pull-in is successful.

The LSOK signal generation circuit 204 includes a positive/negative determination circuit 2041, a delay 2042, and an XOR circuit 2043.

The positive/negative determination circuit 2041 determines whether the LE signal is positive or negative. When the LE signal is greater than Vref, the positive/negative determination circuit 2041 outputs a high Level. When the LE signal is smaller than Vref, the positive/negative determination circuit 2041 outputs a low level. In this way, the positive and negative in the positive/negative determination circuit 2041 means the positive and negative of the LE signal based on Vref.

The delay 2042 delays the output signal of the positive/negative determination circuit 2041 by a predetermined time Ts.

The XOR circuit 2043 outputs the result of the XOR of the output signal of the positive/negative determination circuit 2041, and the output signal of the delay 2042, as a signal of high or low level.

As a result, the LSOK signal generation circuit 204 outputs a high level, only when the positive/negative of the LE signal before the predetermined time Ts and the positive/negative of the current LE signal are different. In other words, by appropriately setting the predetermined time Ts, the LSOK signal generation circuit 204 functions as a circuit for detecting the time when the LE signal crosses the reference voltage Vref. Further, when the LE signal crosses the reference voltage Vref and monotonically increases or decreases, the LSOK signal is high only during the period of Ts at the time when the LE signal crosses Vref.

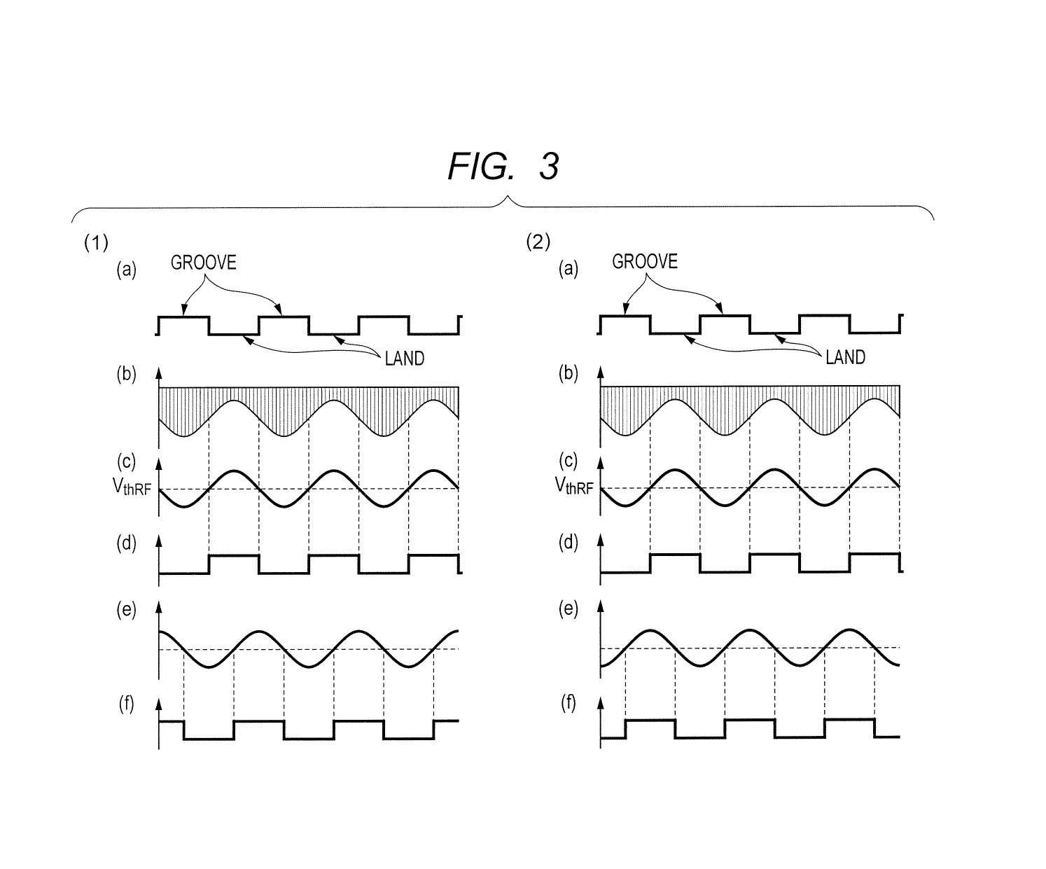

Here, the signals output from the MIRR signal generation circuit 201 and the TZC signal generation circuit 202 will be described with reference to FIG. 3. FIG. 3 shows a schematic diagram of the track, and shows the signal waveforms in the individual parts of the MIRR signal generation circuit 201 and the TZC signal generation circuit 202, when a laser beam crosses the track with the tracking servo turned off. Note that FIG. 3(1) shows the waveforms when the moving direction of the track viewed from the objective lens 1027 is the inner peripheral direction, while FIG. 3(2) shows the waveforms when the moving direction of the track is the outer peripheral direction.

FIG. 3(a) schematically shows the track. FIG. 3(b) shows the RF signal, (c) shows the output signal of the lower envelope detection circuit 2011, (d) shows the MIRRO signal, (e) shows the TE signal, and (f) shows the TZC signal.

The description of this embodiment will focus on the optical disk for groove recording. Here, it is assumed that the track moving over the objective lens 1027 with eccentricity is all the recording section.

In this case, as shown in FIG. 3(a), the amplitude of the RF signal increases when passing through a goove, and the amplitude of the RF signal decreases when passing through a land.

As shown in FIG. 3(b), by appropriately setting the voltage level VthRF, the MIRR signal of FIG. 3(c) is a signal indicating a high level at the time when the land is just above the objective lens 1027. In this embodiment, it is assumed that VthRF is set to the appropriate level as shown in FIG. 3(c).

The TZC signal shown in FIG. 3(f) is a signal obtained by binarizing the TE signal shown in FIG. 3(e). Thus, the phase of the MIRR signal (d) and the phase of the TZC signal (f) are displaced by 90 degrees.

Further, as can be seen from the comparison between FIG. 3(1) and FIG. 3(2), it is generally known that the phase of the MIRR signal and the phase of the TZC signal are inverted by 180 degrees according to the moving direction of the track. Thus, it is possible to detect the moving direction of the track from the phase relationship between the MIRR signal and the TZC signal.

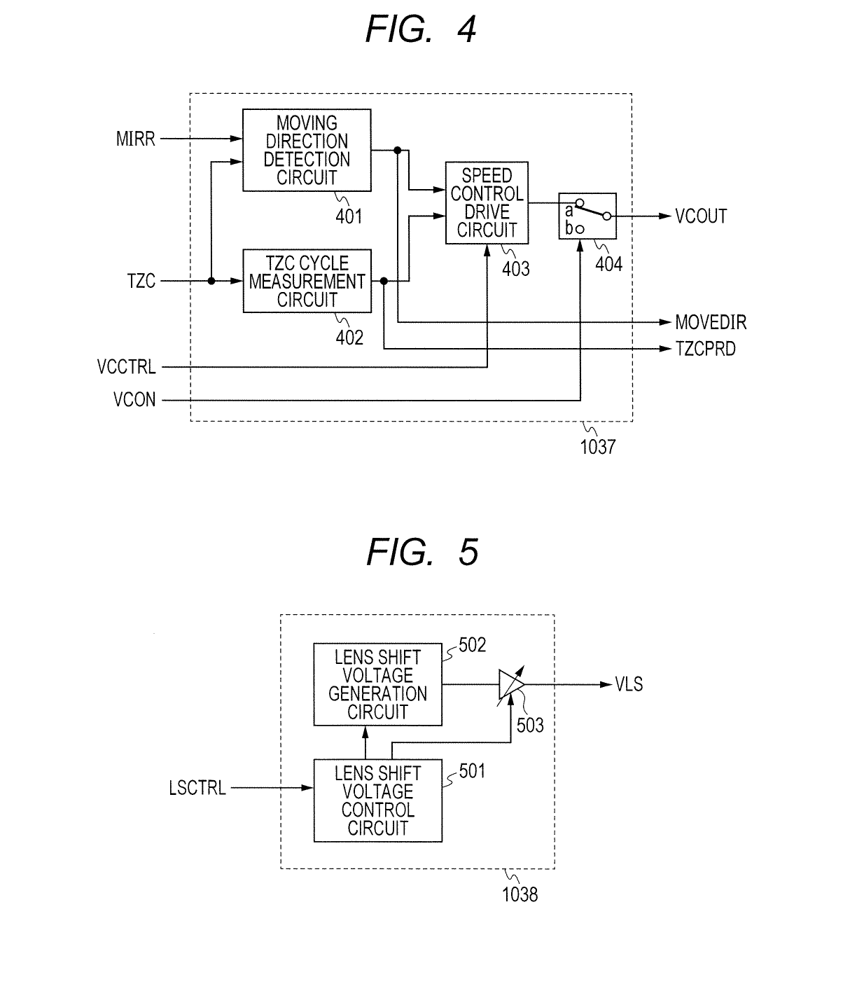

Next, the configuration of the speed control circuit 1037 according to this embodiment will be described with reference to FIG. 4. The speed control circuit 1037 includes a moving direction detection circuit 401, a TZC cycle measurement circuit 402, a speed control drive circuit 403, and a switch 404.

The moving direction detection circuit 401 detects the moving direction of the track from the phase relationship between the MIRR signal and the TZC signal. Then, the moving direction detection circuit 401 outputs the result as moving direction information MOVEDIR.

The TZC cycle measurement circuit 402 measures the cycle of the TZC signal, and outputs the result as TZC cycle information TZCPRD.

The speed control drive control 403 outputs a drive signal to drive the actuator in the radial direction so as to keep the TZC cycle at a predetermined cycle TGTRRD, based on the moving direction information MOVEDIR and the TZC cycle information TZCPRD. At this time, the target cycle TGTPRD of the TZC signal is determined based on the VCCTRL signal from the system control circuit 1031.

The speed control drive circuit 403 obtains the moving direction of the track from the moving direction information MOVEDIR. Then, the speed control drive circuit 403 determines the polarity (positive/negative) of the drive signal to drive the objective lens 1027 in the same direction as the moving direction of the track. Further, the speed control drive circuit 403 compares the current TZC cycle with the target cycle TGTPRD based on the TZC cycle information TZCPRD. Then, the speed control drive circuit 403 outputs the voltage according to the difference between the TZC cycle and the target cycle TGTPRD. In this way, the speed control drive circuit 403 controls the TZC cycle to be kept at the target cycle TGTRRD. As a result, the relative speed between the track and the objective lens 1027 can be kept substantially constant. Note that the speed control described in this embodiment to keep the TZC frequency at the target cycle is also referred to as fine seek.

The switch 404 selects the output signal of the speed control drive circuit 403 or the reference voltage Vref, based on the VCON signal output from the system control circuit 1031. Then, the switch 404 outputs the selected signal as speed control output signal VCOUT. When a high level is input as VCON signal, the switch 404 selects a terminal a, and outputs the output signal of the speed control drive circuit 403 as the VCOUT signal to the actuator. On the other hand, when a low level is input as VCON signal, the switch 404 selects a terminal b, and outputs the reference voltage Vref. As a result, the switch 404 functions as a switch for switching ON/OFF of the speed control. Further, the VCON signal is used as a signal indicating whether the speed control is turned on or off.

Note that the moving direction information MOVEDIR and the TZC cycle information TZCPRD are also output to the system control circuit 1031.

Next, the configuration of the lens shift voltage output circuit 1038 according to this embodiment will be described with reference to FIG. 5.

The lens shift voltage output circuit 1038 includes a lens shift voltage control circuit 501, a lens shift voltage generation circuit 502, and a variable gain 503.

The lens shift voltage control circuit 501 outputs command signals to control the lens shift voltage generation circuit 502 described below and the variable gain 503 described below, based on the LSCTRL signal output from the system control circuit 1031. The lens shift voltage control circuit 501 can use, for example, a common CPU.

The lens shift voltage generation circuit 502 outputs a predetermined voltage level based on a command signal from the lens shift voltage control circuit 501.

The variable gain 503 applies a predetermined gain to the voltage output from the lens shift voltage generation circuit 502, based on a command signal from the lens shift voltage control circuit 501. Then, the variable gain 503 outputs the result as lens shift voltage VLS.

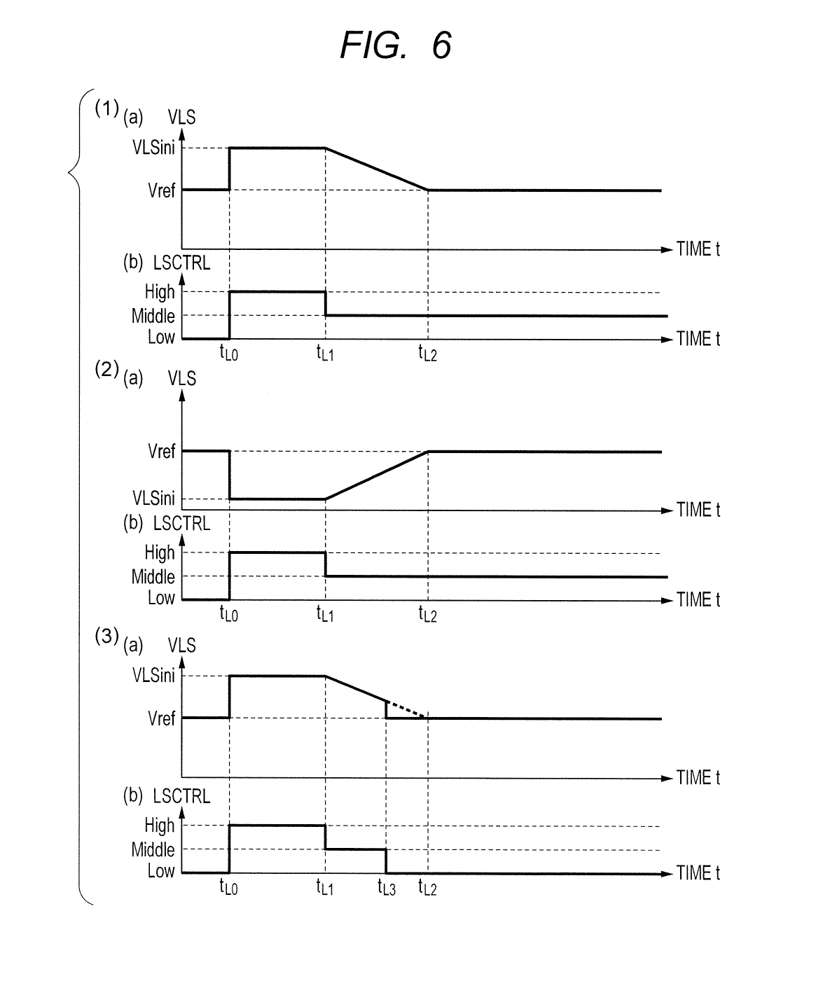

Next, the operation of the lens shift voltage output circuit 1038 according to this embodiment will be described with reference to FIG. 6.

The LSCTRL signal according to this embodiment includes information for transmitting the voltage to be set to the lens shift voltage generation circuit 502, and operation state change information LSMODE to change the operation state of the lens shift voltage output circuit 1038.

The lens shift voltage output circuit 1038 starts predetermined operations according to the level of LSMODE. The individual operations will be described with reference to FIG. 6.

In FIG. 6, (1), (2), and (3) show three cases of different states of the lens shift voltage output circuit 1038.

FIG. 6(a) shows the waveform of the VLS signal which is the output signal of the lens shift voltage output circuit 1038. FIG. 6(b) shows the transition of the operation state change information LSMODE included in the LSCTRL signal. In this embodiment, it is assumed that LSMODE takes three values.

Hereinafter, the three values will be referred to as low level, Middle level, and high level.

As indicated by time t=tL0 in FIG. 6(1), when a high level is input as LSMODE, the lens shift voltage output circuit 1038 starts outputting a predetermined voltage VLSini. Hereinafter, this operation will be referred to as the start of VLS signal output.

Further, as indicated by time t=tL1, when a middle level is input as LSMODE, the lens shift voltage output circuit 1038 starts operation to gradually reduce the amplitude of the VLS signal as the time passes. Hereinafter, this operation will be referred to as the start of VLS signal amplitude reduction.

FIG. 6(1) shows the case in which the VLS signal level is reduced to the reference voltage Vref at time t=tL2. After the level of the VLS signal reaches Vref, the VLS signal is kept unchanged and continues to output Vref.

Here, the amplitude of the VLS signal is the amplitude based on the Vref reference. In other words, although the VLS signal level decreases in FIG. 6(1), the VLS signal level increases as shown in FIG. 6(2) when VLSini is a value smaller than Vref. In both cases, the VLS signal level is gradually approximated to Vref.

FIG. 6(3) shows the case in which a low level is input as LSMODE at time t=tL3. As can be seen from the figure, tL3 is more than tL1 and less than tL2. It is shown that a low level is input as LSMODE from the system control circuit 1031 during the VLS amplitude reduction, after the start of VLS amplitude reduction at time t=tL1.

As indicated by time t=tL3 in FIG. 6(3), when a low level is input as LSMODE, the lens shift voltage output circuit 1038 sets the VLS signal level to Vref. Hereinafter, this operation will be referred to as VLS signal reset.

The operations described above can be realized, for example, by constantly outputting the LSCTRL signal in the lens shift voltage generation circuit 502, and by changing the value of the variable gain 503 according to the level of LSMODE.

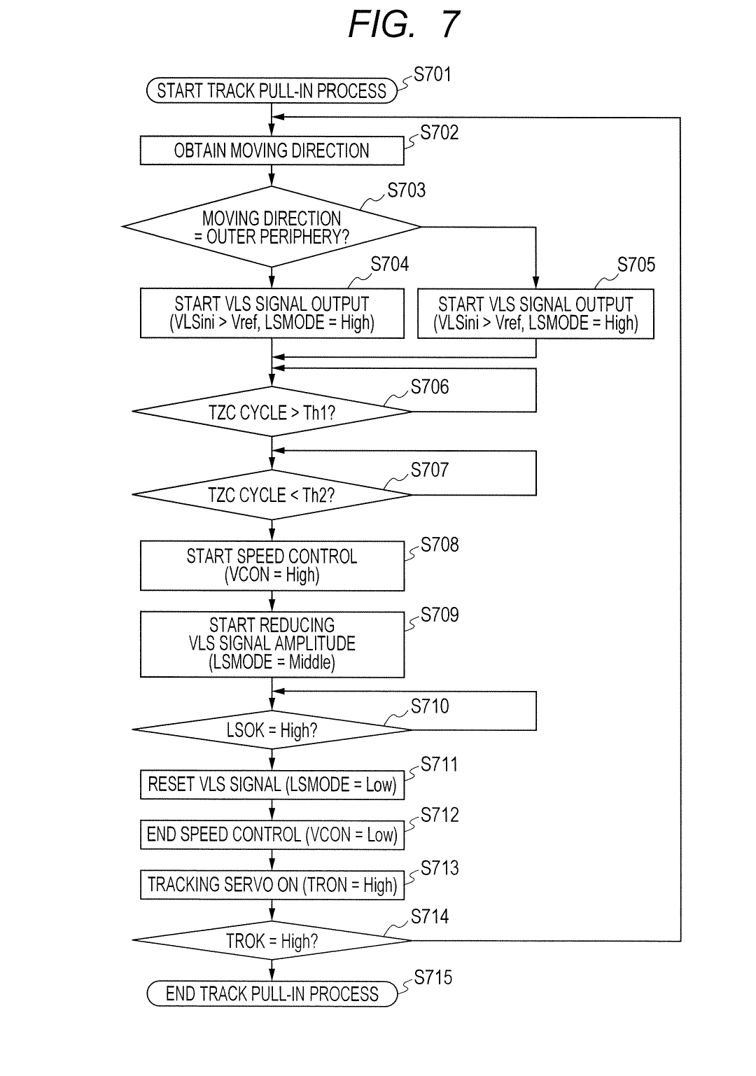

Next, the track pull-in process according to this embodiment will be described with reference to the flow chart of FIG. 7.

When the track pull-in process is started (step S701), the system control circuit 1031 obtains the moving direction of the track from the MOVEDIR information output from the speed control circuit 1037 (step S702).

Next, the process determines whether the moving direction is the outer periphery (step S703). In response to the result of the determination, the process sets the LSCTRL signal to high, and starts outputting the VLS signal. At this time, the process changes the voltage of the voltage VLSini at the start of the VLS signal output, according to the result of the determination in step S703.

In other words, when the moving direction is the outer periphery (Yes in step S703), the process sets VLSini to a voltage greater than Vref, and starts outputting the VLS voltage (step S704). On the other hand, when the moving direction is the inner periphery (No in step S703), the process sets VLSini to a voltage smaller than Vref, and starts outputting the VLS voltage (step S705).

This operation means that the objective lens 1027 is shifted to the outer peripheral side when the moving direction of the track is the outer periphery, and that the objective lens 1027 is shifted to the inner peripheral side when the moving direction of the track is the inner periphery.

After step S704 or step S705, the process monitors the cycle of the TZC signal from the TZCPRD information output from the speed control circuit 1037. Then, the process determines whether the cycle of the TZC signal is greater than a predetermined time Th1 (step S706).

When the cycle of the TZC signal is smaller than the predetermined time Th1 (No in step S706), the process returns again to step S706. In other words, the process waits until the cycle of the TZC signal is greater than the predetermined time Th1.

When the cycle of the TZC signal is greater than the predetermined time Th1 (Yes in step S706), the process then determines whether the cycle of the TZC signal is smaller than a predetermined time Th2 (step S707).

When the cycle of the TZC signal is greater than the predetermined time Th2 (No in step S707), the process returns again to step S707. In other words, the process waits until the cycle of the TZC signal is smaller than the predetermine time Th2.

When the cycle of the TZC signal is smaller than the predetermined time Th2 (Yes in step S707), the process sets the VOCN signal to high and then starts speed control (step S708).

In other words, the operation from step S706 to step S707 is the operation of first waiting until the TZC cycle is greater than the predetermined time Th1, and then waiting until the TZC cycle is smaller than the predetermined time Th2. More specifically, as the TZC signal is obtained by binarizing the TE signal, the operation from step S706 to step S707 is the operation of first waiting until the zero crossing of the TE signal is slow, and then waiting until the zero crossing of the TE signal is fast. By appropriately setting the predetermined times Th1 and Th2, the operation from step S706 to step S707 can function as an operation of waiting for the eccentric fold to be detected.

After step S708, the process sets the LSCTRL signal to middle, and then starts VLS amplitude reduction (step S709).

After step S709, the process determines whether the LSOK signal is a high level (step S710).

When the LSOK signal is not a high level (No in step S710), the process returns again to step S710. In other words, the process waits until the LSOK signal is set to a high level.

When the LSOK signal is a high level (Yes in step S710), the process sets the LSCTRL signal to low, and resets the VOS voltage (step S711). Then, the process sets the VOCN signal to low, and then ends the speed control (step S712).

After step S712, the process sets the IRON signal to high, and then turns on the tracking servo (step S713).

Next, the process monitors the TROK signal to determine whether the TROK signal is set to high in a predetermined time (step S714). When the TROK signal is set to high in the predetermined time (Yes in step S714), the process determines that the track pull-in is successful, and then ends the track pull-in process (step S715).

When the TROK signal is not set to high in the predetermined time (No in step S714), the process returns to step S702 to retry the track pull-in process.

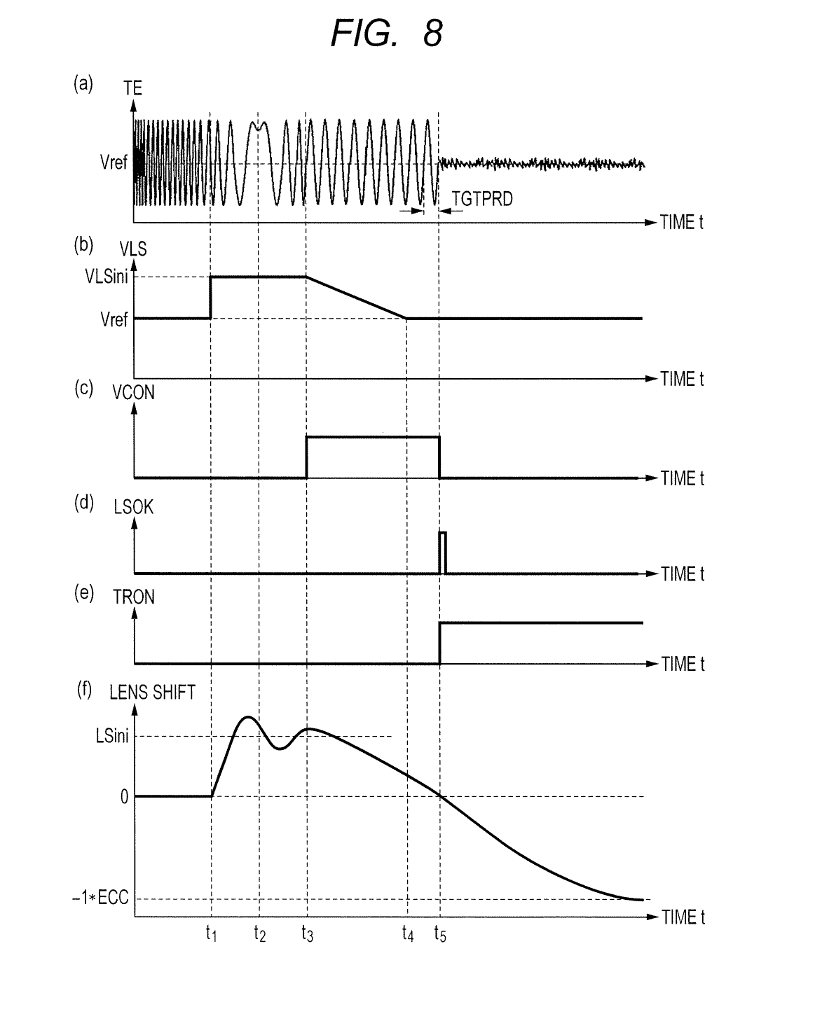

Next, the operation of the track pull-in process according to this embodiment will be described with reference to FIG. 8.

FIG. 8 shows the waveforms of the individual parts in the track pull-in process. In FIG. 8, (a) shows the TE signal, (b) shows the VLS signal, (c) shows the VCON signal, (d) shows the LSOK signal, (e) shows the IRON signal, and (f) shows the lens shift of the objective lens 1027.

Here, the LE signal is the signal indicating the lens shift of the objective lens 1027. Thus, the waveform of the LE signal has the same shape as the waveform in FIG. 8(f). For this reason, the waveform in FIG. 8(f) can be replaced by the waveform of the LE signal if the value of the vertical axis is ignored.

Time t1 is the start time of the track pull-in process. Although the moving direction of the track is not shown in FIG. 8, it is shown that the track moves in the outer peripheral direction at time t1. Because it is determined that the track moves in the outer peripheral direction, the VS voltage output is started with VLSini set to a voltage greater than Vref in (b). As a result, the objective lens 1027 moves to the outer peripheral side and lens shift occurs in (f). Note that LSini in (f) is the lens shift at the position to which the objective lens 1027 finally moves when the voltage VLSini is given as the TRD signal.

Assuming α[V/um] is the conversion rate of the LE signal and the lens shift of the objective lens 1027, LSini can be expressed by the following equation:

LSini=α·VLSini

As shown in FIG. 8(f), the objective lens 1027 vibrates and moves to the lens shift position of LSini.

Time t2 is the time when the cycle of the TE signal is the maximum value. In other words, time t2 is the time when the eccentricity is folded. At this time, the moving speed of the track is zero. The moving direction of the track is reversed after time t2, and the track starts moving in the inner peripheral direction. When the track moves in the inner peripheral direction, the cycle of the TE signal is faster. However, in this embodiment, the process monitors the TZC cycle and waits for the eccentric fold to be detected.

Time t3 is the time when the eccentric fold is detected (corresponding to the time determined as “Yes” in step S707). In this embodiment, the process waits until the TZC cycle is greater than the predetermined time Th1, and then waits until the TZC cycle is smaller than the predetermined time Th2, in order to detect the eccentricity fold. As a result, the detection is delayed until the TZC cycle is smaller than Th2. Thus, time t2 and time t3 are not the same.

At time t3, VCON is set to high and the speed control is started in (c), and the VLS amplitude reduction is started in (b).

As described above, the moving direction of the track is the direction from the outer periphery to the inner periphery. Thus, as a result of the speed control, the objective lens 1027 is also driven in the direction from the outer periphery to the inner periphery. The speed control circuit controls the cycle of the TZC signal, which is obtained by binarizing the TE signal, to match the target cycle TGTPRD. Thus, the relative speed is kept substantially constant.

For this reason, the TE signal in (a) is not dense after the time when the TE signal is thin, so that the cycle of the TE signal is substantially constant. At the same time, the lens shift shown in (f) decreases. In this embodiment, the speed control is started after the moving direction of the track is changed to the inner peripheral direction in the state in which the lens has been shifted to the outer peripheral side by LSini. So the lens shift changes from the value in the vicinity of LSini to the neutral position where the lens shift is zero.

Time t4 is the time when the VLS amplitude decreases and reaches Vref.

Time t5 is the time when the lens shift is negative. At this time, as shown in (d), the LSOK signal is set to a high level. In response to this, the process sets VCON to a low level and then ends the speed control in (c). At the same time, the process sets TROM to high, and then turns on the tracking servo. As a result, the track pull-in is successful with the TE signal in (a).

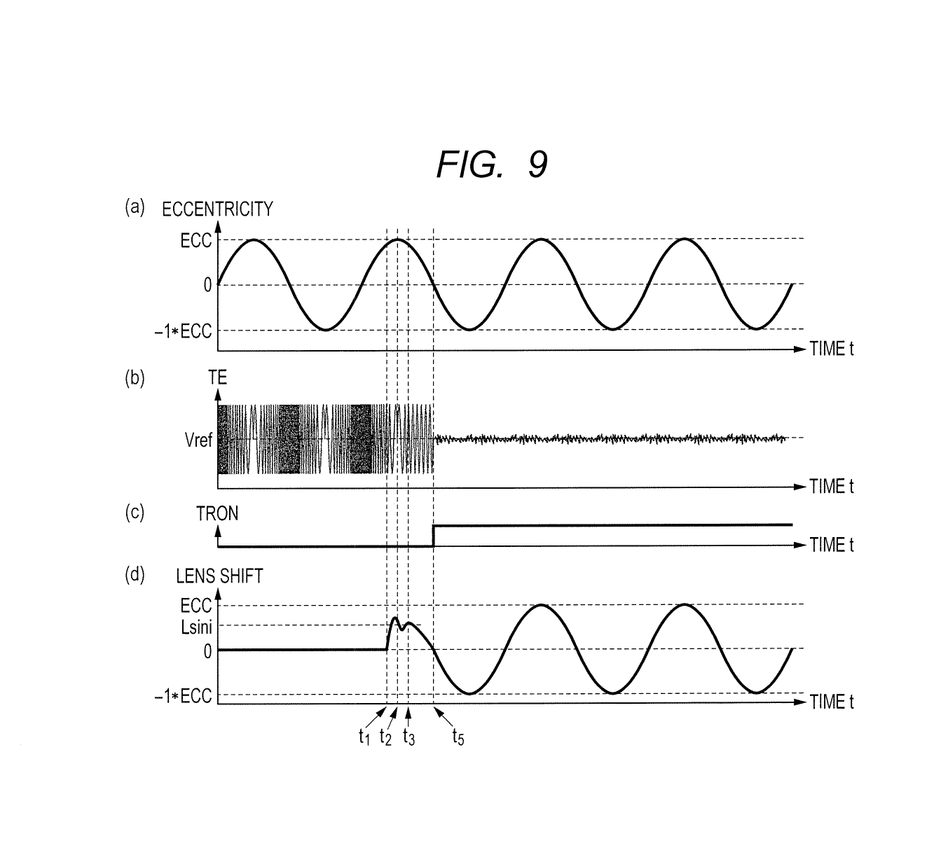

Next, the effect of this embodiment will be described with reference to FIG. 9.

FIG. 9 shows various waveforms when the track pull-in process is performed. In FIG. 8, the internal signals such as VCON signal and LSOK signal are described in detail for the purpose of illustrating the track pull-in operation according to this embodiment. However, these signals are omitted in FIG. 9.

FIG. 9(a) shows the eccentricity, (b) shows the TE signal, (c) shows the TRON signal, and (d) shows the lens shift of the objective lens 1027.

Times t1, t2, t3, and t5 are the same as the times shown in FIG. 8, so that the description thereof will be omitted.

In the track pull-in process according to this embodiment, the process waits for the eccentricity fold at time t2 and then starts speed control from time t3 in the state in which the lens has been shifted at time t1. Then, the process starts track pull-in at time t5 when the lens shift is zero.

When the track pull-in at time t=t5 is successful, the objective lens 1027 then follows the pulled-in track along the eccentricity shown in FIG. 9(a). Thus, the transition of the lens shift after t=t5 is within the range of ±ECC as shown in FIG. 9(d). This is because the track pull-in is performed at the time when the lens shift is zero.

As described above, with the optical disk device according to this embodiment, it is possible to solve the problem of the conventional technology in which the lens shift is twice the eccentricity ECC after a half cycle from the track pull-in. As a result, the influence of the visual field characteristics can be reduced and the track pull-in performance can be improved.

It is to be noted that, in this embodiment, the process first obtains the moving direction in step S702, changes the direction of the lens shift according to the obtained result, and then detects the time when the cycle of the TE signal is the maximum value in steps S706 and S707. However, the present invention is not limited to the process method of this embodiment, as long as it is possible to perform the speed control in the direction opposite to the direction in which the lens has been shifted at time t1 in FIG. 8.

For example, the process of obtaining the moving direction in step S702 can be omitted. For example, the process must shift the lens to the outer periphery at time t1 in FIG. 8. Then, the process monitors the moving direction information TRMOVE, and waits until the moving direction of the track is the inner peripheral direction. At the time when the moving direction of the track changes to the inner peripheral direction, the process determines the time of the speed control shown in time t3. In this case also, the waveforms are the same as those shown in FIG. 8.

In both cases, the process performs the speed control in the direction opposite to the direction in which the lens has been shifted. In this way, the objective lens can be speed-controlled in the direction in which the lens shift decreases. As a result, it is possible to perform the track pull-in at the time when the lens shift is zero, and to suppress the lens shift immediately after the track pull-in operation. Thus, with the optical disk according to this embodiment, the influence of the visual field characteristics can be reduced and the track pull-in performance can be improved.

Further, with the optical disk device according to this embodiment, the tracking servo is turned on after the relative speed between the track and the objective lens is reduced by the speed control. Thus, it is possible to improve the track pull-in performance.

With the operation described above, the optical disk device according to the first embodiment can improve the track pull-in performance.

### Second Embodiment

A second embodiment will be described below.

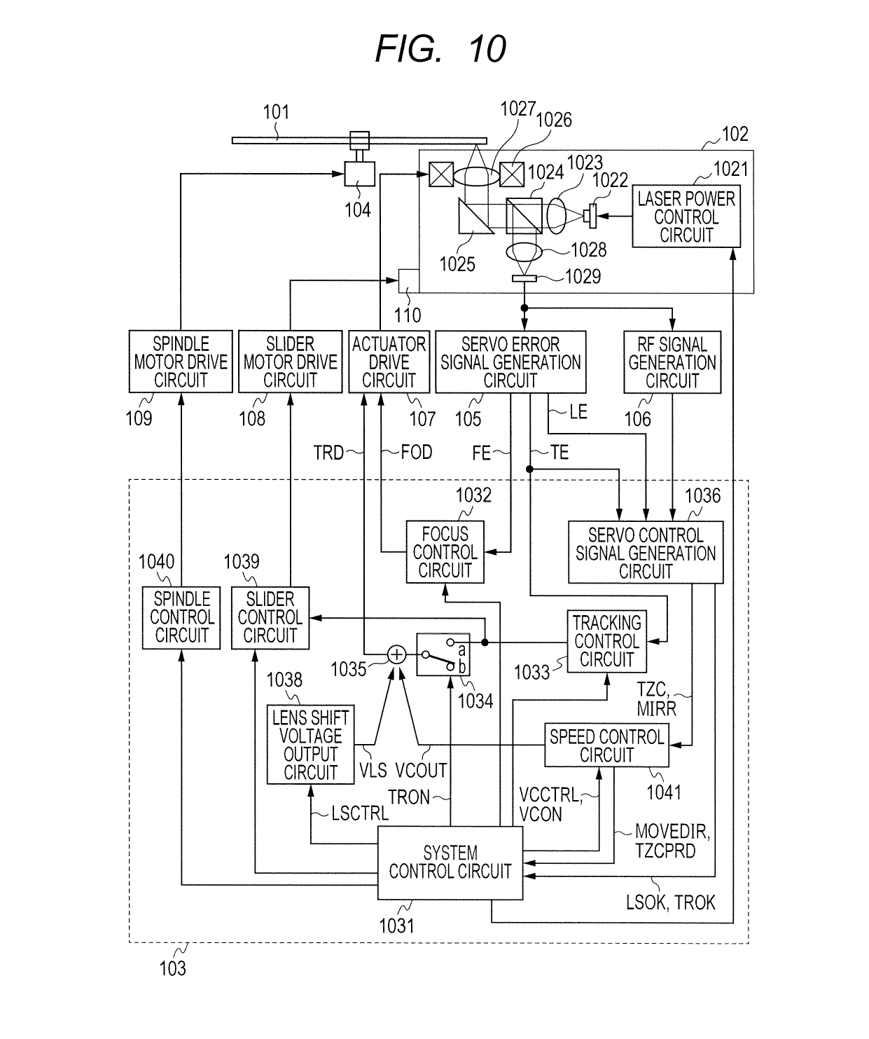

FIG. 10 is a block diagram of the optical disk device according to the second embodiment. The same components as those shown in FIG. 1, which is a block diagram of the first embodiment, are denoted by the same reference numerals, and the description thereof will be omitted.

A speed control circuit 1041 according to this embodiment outputs a signal VCOUT to perform speed control by driving the actuator, based on the TZC signal and MIRR signal output from the servo control signal generation circuit 1036. At the time of the speed control, the parameters for the speed control are set according to the signal VCCTRL output from the system control circuit 1031. Further, the ON/OFF of the drive signal is controlled by the VCON signal.

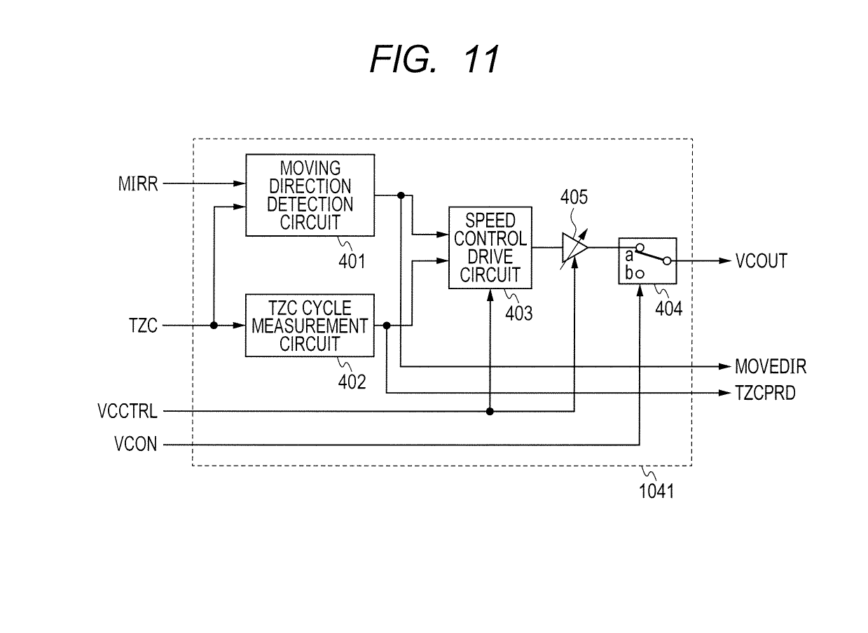

Next, the configuration of the speed control circuit 1041 according to this embodiment will be described with reference to FIG. 11. The same components as those shown in FIG. 4, which is a block diagram of the speed control circuit of the first embodiment, are denoted by the same reference numerals, and the description thereof will be omitted.

A speed control output variable gain 405 applies a predetermined gain VCGAIN to the output signal of the speed control drive circuit 403. Then, the speed control output variable gain 405 outputs the signal with the predetermined gain VCGAIN. The gain VCGAIN is set based on the VCCTRL information output from the system control circuit 1031.

The output signal of the speed control output variable gain 405 is connected to the terminal a of the switch 404. When a high level is input as VCON, the signal is output to the actuator. Then, the speed control is performed.

The VCCTRL signal in this embodiment includes information about the value VCGAIN that is set to the speed control output variable gain 405, in addition to the target cycle TGTPRD of the TZC signal.

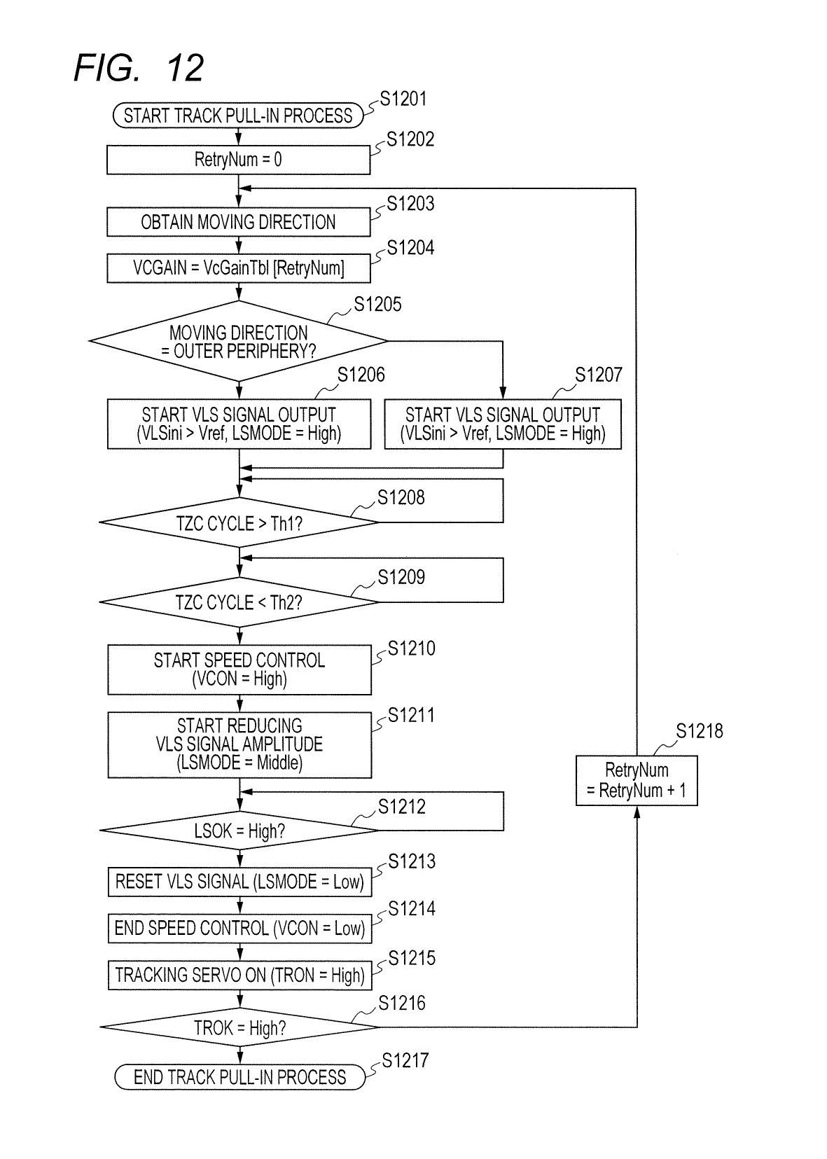

Next, the track pull-in process according to this embodiment will be described with reference to the flow chart of FIG. 12.

When the track pull-in process is started (Step S1201), the system control circuit 1031 initializes an internal variable RetryNUM to zero (step S1202). The variable RetryNum is a variable for counting the number of track pull-in retry attempts.

After step S1202, the process obtains the moving direction of the track from the MOVEDIR information output from the speed control circuit 1041 (step S1203). Next, the process changes the value VCGAIN that is set to the speed control output variable gain 405, based on an alignment VcGainTb1 according to Retry Num (step S1204). The alignment VcGainTb1 will be described in detail below.

Then, the process determines whether the moving direction is the outer periphery (step S1205). In response to the result of the determination, the process sets the LSCTRL signal to high, and starts outputting the VLS signal. At this time, the process changes the voltage of the voltage VLSini at the start of the VLS signal output, according to the result of the determination in step S1205.

In other words, when the moving direction is the outer periphery (Yes in step S1205), the process sets VLSini to a voltage greater than Vref, and starts outputting the VLS voltage (step S1206). On the other hand, when the moving direction is the inner periphery (No in step S1205), the process sets the voltage VLSini to a voltage smaller than Vref, and starts outputting the VLS voltage (step S1207).

This means that the objective lens 1027 is shifted to the outer peripheral side when the moving direction of the track is the outer periphery, while the objective lens 1027 is shifted to the inner peripheral side when the moving direction of the track is the inner periphery.

After step S1206 or S1207, the process monitors the cycle of the TZC signal from the TZCPRD information output from the speed control circuit 1041. Then, the process determines whether the cycle of the TZC signal is greater than the predetermined time Th1 (step S1208).

When the cycle of the TZC signal is smaller than the predetermined time Th1 (No in step S1208), the process returns again to step S1208. In other words, the process waits until the cycle of the TZC signal is greater than the predetermined time Th1.

When the cycle of the TZC signal is greater than the predetermined time Th1 (Yes in step S1208), the process then determines whether the cycle of the TZC signal is smaller than the predetermined time Th2 (step S1209).

When the cycle of the TZC signal is greater than the predetermined time Th2 (No in step S1209), the process returns again to step S1209. In other words, the process waits until the cycle of the TZC signal is smaller than the predetermined time Th2.

When the cycle of the TZC signal is smaller than the predetermined time Th2 (Yes in step S1209), the process sets the VCON signal to high and starts the speed control (step S1210).

In other words, the operation from step S1208 to step S1209 is the operation of first waiting until the TZC cycle is greater than the predetermined time Th1, and then waiting until the TZC cycle is smaller than the predetermined time Th2. More specifically, as the TZC signal is obtained by binarizing the TE signal, the operation from step S1208 to step S1209 is the operation of first waiting until the zero crossing of the TE signal is slow, and then waiting until the zero crossing of the TE signal is fast. By appropriately setting the predetermined times Th1 and Th2, can function as an operation of waiting for the eccentric fold to be detected.

After step S1210, the process sets the LSCTRL signal to middle, and starts reducing the VLS amplitude (step S1211).

After step S1211, the process determines whether the LSOK signal is a high level (step S1212).

When the LSOK signal is not a high level (No in step S1212), the process returns again to step S12121. In other words, the process waits until the LSOK signal is set to a high level.

When the LSOK signal is a high level (Yes in step S1212), the process sets the LSCTRL signal to low, and resets the VLS voltage (step S1213). Then, the process sets the VCON signal to low, and then ends the speed control (step S1214).

After step S1214, the process sets the IRON signal to high, and then turns on the tracking servo (step S1215).

Next, the process monitors the TROK signal to determine whether the TROK signal is set to high in a predetermined time (step S1216). When the TROK signal is set to high in the predetermined time (Yes in step S1216), the process determines that the track pull-in is successful, and then ends the track pull-in process (step S1217).

When the TROK signal is not set to high in the predetermined time (No in step S1216), the process adds 1 to the internal variable RetryNum, and increments the count of the track pull-in retry number (step S1218). Then, the process returns to step S1203 to retry the track pull-in process.

Here, the alignment VcGainTb1 will be described with reference to FIG. 13. The alignment VcGainTb1The is used to determine the value VCGAIN that is set to the speed control output variable gain 405 in step S1204.

FIG. 13 is a view of the alignment VcGainTb1. The alignment VcGainTb1 is the retry alignment that is set to the speed control output variable gain 405. Here, the values of VcGainTb1 for the case when the retry attempt failed three times or more, are omitted.

From the alignment VcGainTb1, in the first track pull-in process, the retry number RetryNum of track pull-in attempts is zero, so that VcGain=0 dB. While it is found that VcGain=3 dB when the track pull-in process failed one time, and VcGain=6 dB when the track pull-in process failed twice.

As VcGain is the value to be set to the speed control output variable gain 405, the amplitude gain of the output signal of the speed control drive circuit 403 is gradually increased in the retry of the track pull-in process.

Next, the effect of this embodiment will be described.

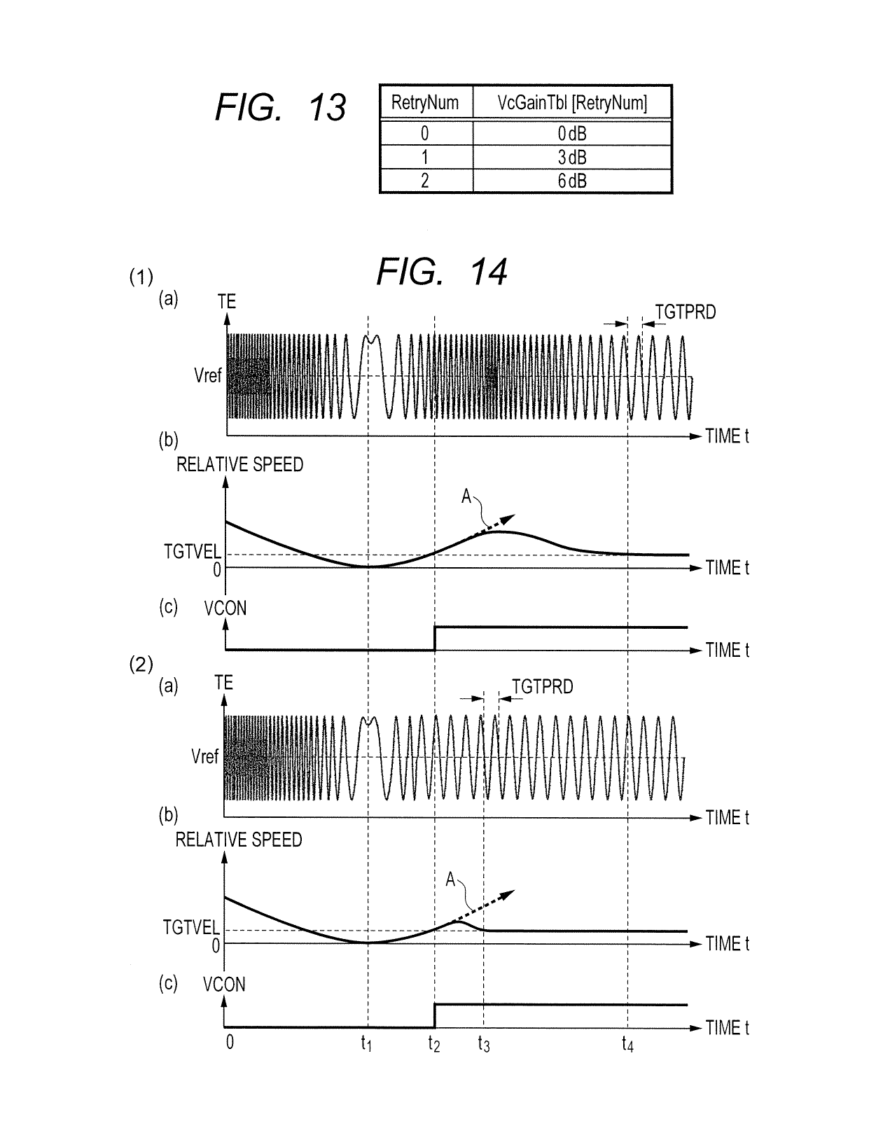

FIG. 14 shows how the relative speed changes before and after the change in the speed control output variable gain 405. FIG. 14(1) shows the waveforms when the speed control output variable gain 405 is not changed (VcGain=0 dB). FIG. 14(2) shows the waveforms when the speed control output variable gain 405 is changed (VcGain=6 dB).

In FIGS. 14(1) and (2), (a) shows the TE signal, (b) shows the relative speed between the track and the objective lens 1027, and (c) shows the VCON signal.

Further, in (b), the value to which the relative speed between the track and the objective lens 1027 converges as a result of the speed control, depends on the target cycle TGTPRD of the TZC signal that is determined based on the VCCTRL signal from the system control circuit 1031. Thus, in FIGS. 14(1) and (2), the relative speed converges to the same value. Assuming that this value is represented by TGTVEL, the value can be the target moving speed corresponding to the target cycle TGTPRD.

Further, the arrow marked A schematically shows the change in the relative speed when the speed control is not performed at t=t2.

Here, time t1 is the time the TE signal is thin, t2 is the time the speed control is started, t3 is the time the speed control is stabilized when the speed control output variable gain 405 is changed (VcGain=6 dB), and t4 is the time the speed control is stabilized when the speed control output variable gain 405 is not changed (VcGain=0 dB).

In FIG. 14(1), after the start of the speed control at time t2, the gain of the speed control is so small that the relative speed does not immediately follow the moving speed of the track, and changes along the arrow A for a while. Then, the relative speed decreases. Finally the relative speed converges to the target moving speed TGTVEL at time t4.

Here, it takes the time, from time t2 to time t4, until the speed control is stabilized. The distance the objective lens 1027 moves during this time is obtained by the integration of the speed of the objective lens 1027. If the value is greater than the voltage VLSini at the time of the start of the VLS signal output, LSOK is high before the speed control is stabilized (Yes in step S1012 in FIG. 12). As a result, the tracking servo is turned on.

Here, the second problem to be solved by the present invention is the degradation of the track pull-in performance due to the difference in the speed between the track and the objective lens 1027 at the time when the tracking servo is turned on.

Thus, the second problem will not be solved if it takes time to stabilize the speed control.

On the other hand, as described in FIG. 20(d) showing the moving speed waveform of the track viewed from the objective lens, the larger the eccentricity ECC of the optical disk, the higher the moving speed of the track at the time when the TE signal is dense.

The speed control is the control to keep substantially constant the relative speed which is the difference between the moving speed of the track and the moving speed of the objective lens 1027. For this reason, it will take a longer time to stabilize the speed control in the case of the optical disk with a large eccentricity ECC.

Thus, the second problem will not be solved if the speed control gain is not sufficient in the case of the optical disk with a large eccentricity. This embodiment is the configuration to solve this problem, allowing the speed control to follow faster by increasing the value of the speed control output variable gain 405 in the retry of the track pull-in process.

FIG. 14(2) shows the waveforms when the speed control output variable gain 405 is changed (VcGain=6 dB). In this case, the speed control output variable gain 405 is increased, so that the amplitude of the speed control output is increased. Thus, the change in the relative speed immediately after time t=t2 is increased. As a result, the convergence of the relative speed is faster. In this way, by increasing the gain of the speed control, it is possible to make the following of the speed control faster.

It is to be noted that when the gain of the speed control is increased, an overshoot occurs, leading to an increase in the time from when the relative speed approaches the target speed TGTVEL until it converges completely. However, in terms of the solution of the second problem, controlling the relative speed to be exactly equal to TGTVEL is not important, but at least the relative speed can be reduced at the time when the tracking servo is turned on. In other words, the track pull-in performance can be improved when the relative speed is a value near TGTVEL.

As described above, even if an overshoot occurs, the speed control gain can be increased to make the convergence of the relative speed faster in the case of the optical disk with a large eccentricity.

Thus, as described in this embodiment, by increasing the speed control gain by the retry, it is possible to make the track pull-in successful, even in the case of the optical disk with a large eccentricity.

With the above operation, the optical disk device of the second embodiment can improve the track pull-in performance.

### Third Embodiment

A third embodiment will be described below.

The first and second embodiments are configured to generate the MIRR signal from the RF signal to perform the speed control by using the generated MIRR signal. However, the RF signal is output only when pits are formed as BD-ROM disks, or only when a mark is formed as in the recorded area of BD-ROM disks. In other words, for example, the RF signal is not output in the unrecorded area of an optical recording disk such as BD-R disk. As a result, the MIRR signal is not generated correctly.

When the MIRR signal is not generated correctly, it is difficult to use the method for determining the moving direction of the track from the phase relationship between the MIRR signal and the TZC signal. Meanwhile, the moving direction of the track may not be detected only by the TE signal. An explanation will be given using FIG. 20. As shown in FIG. 20(a), the track moves in the outer peripheral direction from point A to point K, and it moves in the inner peripheral direction from point K to point A. At this time, however, the TE signal is as shown in FIG. 20(b) in which there is no difference in the waveforms between the two directions. For this reason, the moving direction of the track may not be detected only by the TE signal. Thus, there is no way to know the moving direction of the track in the unrecorded area of the optical recording disk.

This embodiment is configured to perform the speed control without using the MIRR signal, in order to improve the track pull-in performance even in the unrecorded area of the optical recording disk.

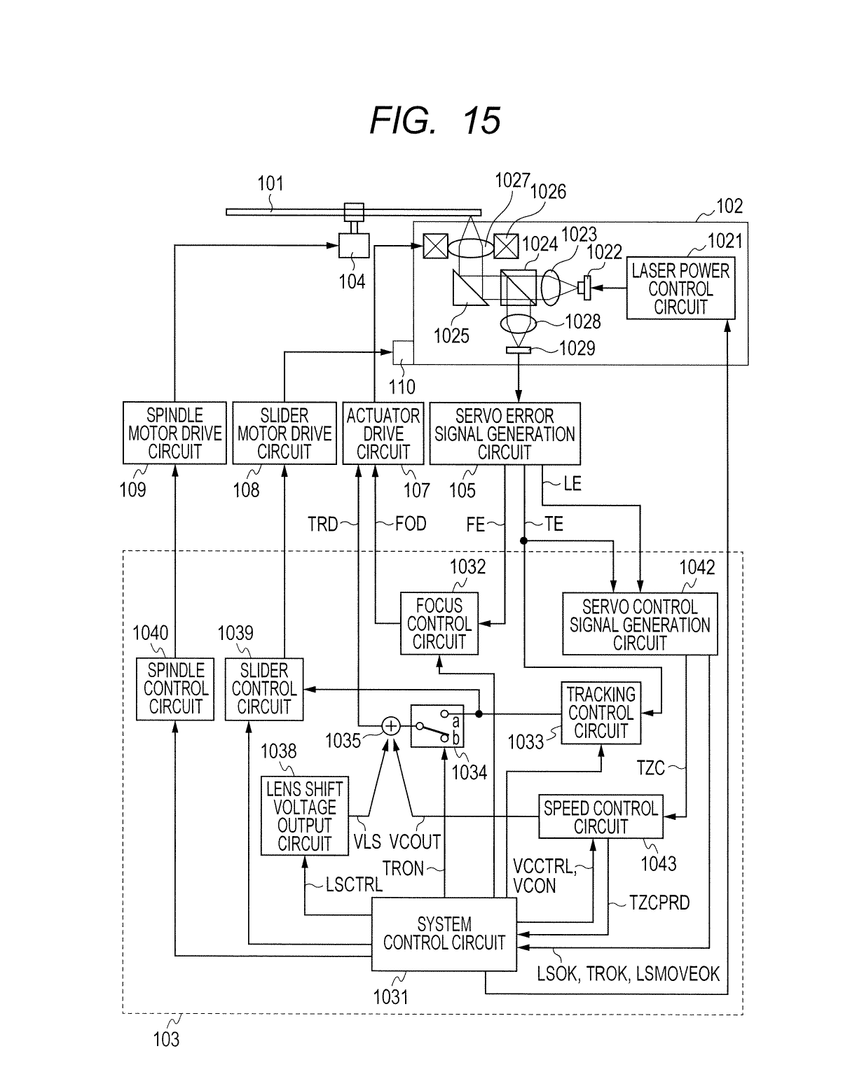

FIG. 15 is a block diagram of the optical disk device according to this embodiment. The same components as those shown in FIG. 1, which is a block diagram of the first embodiment, are denoted by the same reference numerals, and the description thereof will be omitted.

A servo control signal generation circuit 1042 generates a control signal based on the input of the TE signal and LE signal output from the servo error signal generation circuit 105. The servo control signal generation circuit 1042 of this embodiment generates and outputs TZC signal, TROK signal, LSOK signal, and LSMOVEOK signal. Of these signals, the TROK signal, the LSOK signal and the LSMOVEOK signal are output to the system control circuit 1031.

A speed control circuit 1043 outputs the signal VCOUT to perform speed control by driving the actuator, based on the TZC signal output from the servo control signal generation circuit 1042. At the time of the speed control, the parameters for the speed control are set according to the signal VCCTRL output from the system control circuit 1031. Further, the ON/OFF of the drive signal is controlled by the VCON signal.

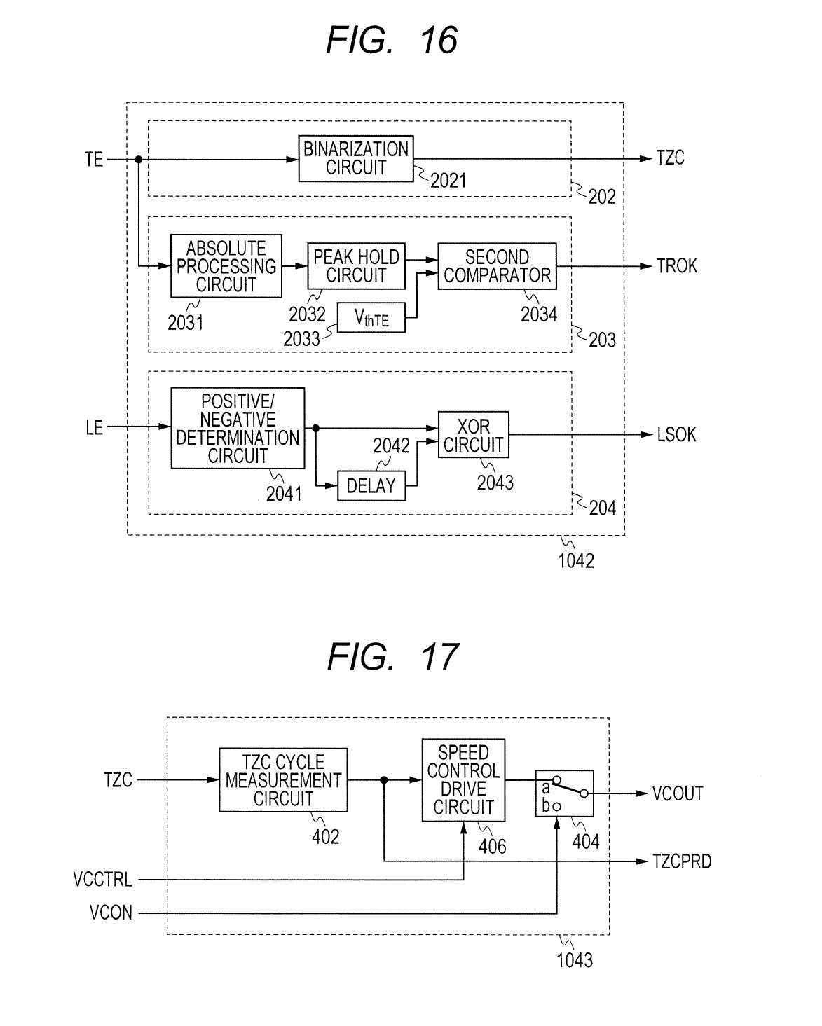

Next, the configuration of the servo control signal generation circuit 1042 according to this embodiment will be described with reference to FIG. 16. The same components as those shown in FIG. 2, which is a block diagram of the servo control signal generation circuit in the first embodiment, are denoted by the same reference numerals, and the description thereof will be omitted.

The servo control signal generation circuit 1042 generates and outputs TZC signal, TROK signal, LSOK signal, and LSMOVEOK signal based on the input of the TE signal and the LE signal. The servo control signal generation circuit 1042 includes the TZC signal generation circuit 202, the TROK signal generation circuit 203, and the LSOK signal generation circuit 204.

The difference between the servo control signal generation circuit 1042 in this embodiment, and the servo control signal generation circuit 1036 in the first embodiment is that the servo control signal generation circuit 1042 does not have the MIRR signal generation circuit 201.

The configuration of the speed control circuit 1043 according to this embodiment will be described with reference to FIG. 17. The same components as those shown in FIG. 4, which is a block diagram of the speed control circuit in the first embodiment, are denoted by the same reference numerals, and the description thereof will be omitted.

The speed control circuit 1043 includes the TZC cycle measurement circuit 402, the speed control drive circuit 406, and the switch 404.

The speed control drive circuit 406 outputs a drive signal to drive the actuator in the radial direction so as to keep the TZC cycle at the predetermined cycle TGTRRD, based on the VCCTRL signal and the TZC cycle information TZCPRD. The target cycle TGTPRD of the TZC signal is determined based on the VCCTRL signal from the system control circuit 1031. Further, the direction (the inner peripheral direction or the outer peripheral direction) to drive the objective lens 1027 is determined based on the VCCTRL signal.

It is to be noted that the TZC cycle information TZCPRD is also output to the system control circuit 1031.

Here, the speed control is the control to keep substantially constant the relative speed which is the difference between the moving speed of the track and the moving speed of the objective lens 1027. Thus, the drive start direction (the inner peripheral direction or the outer peripheral direction) of the objective lens 1027 at the time of the start of the speed control, is the same as the moving direction of the track. However, in this embodiment, the speed control circuit 1043 is configured to perform the speed control without using the MIRR signal, so there is no way to know the moving direction of the track. Thus, the speed control circuit 1043 may not be able to determine the direction (the inner peripheral direction or the outer peripheral direction) in which the objective lens 1027 should be driven at the time of the start of the speed control.

In this embodiment, the VCCTRL signal output from the system control circuit 1031 includes information about the direction in which the objective lens 1027 is driven in the speed control, in addition to the target cycle TGTPRD of the TZC signal. The system control circuit 1031 indicates the direction in which the objective lens 1027 should be driven in the speed control. In other words, this means that the system control circuit 1031 assumes the moving direction of the track to perform the speed control.

Here, the speed control with an incorrect assumption will be described. For example, the speed control is performed in such a manner that the system control circuit 1031 indicates the outer peripheral direction as the direction in which the objective lens 1027 is driven, although the moving direction of the track is the inner peripheral direction.

In this case, the speed control drives the objective lens 1027 in the outer peripheral direction, so that the relative speed increases. The speed control controls the relative speed with the assumption that the moving direction of the track and the moving direction of the objective lens 1027 are the same. In this case, the speed control determines that the relative speed increases due to the lack of the drive output. In other words, the speed control increase the drive output to a higher level. As a result, the relative speed is controlled by the direction in which the relative speed further increases.

Thus, when focusing on the cycle of the TE signal, the cycle of the TE signal does not reach the target cycle TGTPRD but decreases rapidly at the same time of the start of the speed control. In other words, the TE signal becomes dense.

As described above, it is possible to determine whether the assumption of the moving direction of the track is correct, by the cycle of the TE signal as a result of the speed control.

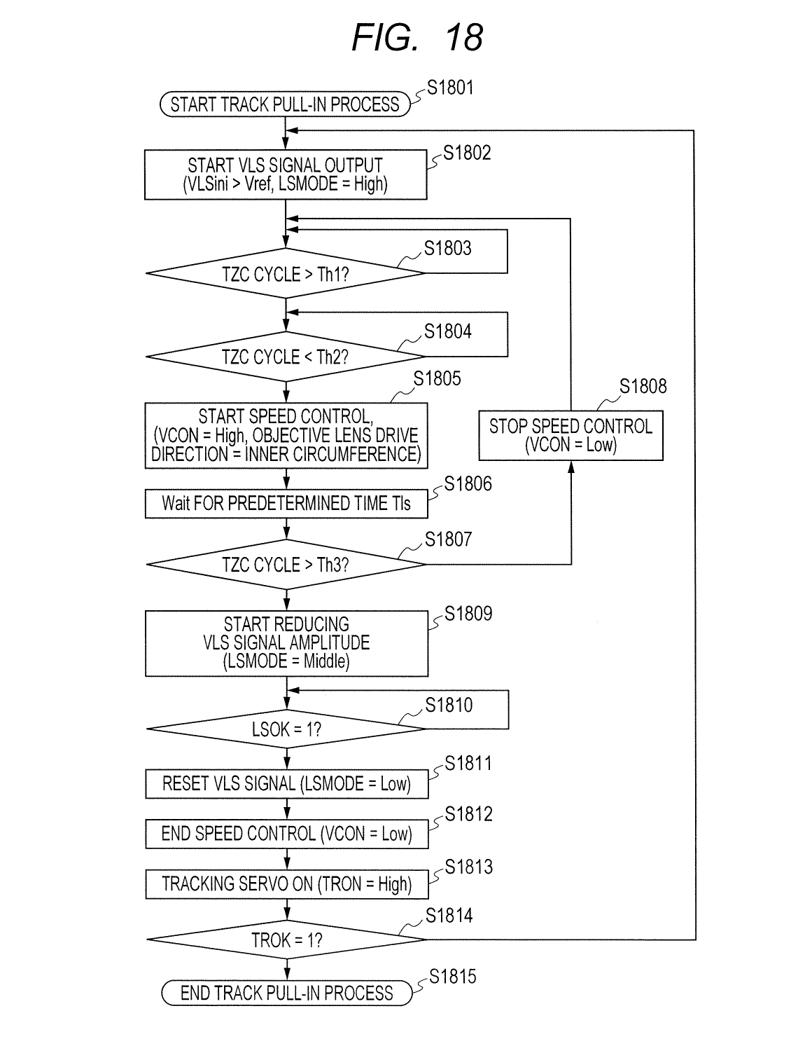

Next, the track pull-in process according to this embodiment will be described with reference to the flow chart of FIG. 18.

When the track pull-in process is started (step S1801), the system control circuit 1031 sets VLSini to a voltage greater than Vref, and starts outputting the VLS voltage (step S1802). This means that the objective lens 1027 is shifted to the outer peripheral direction.

Next, the process monitors the cycle of the TZC signal from the TZCPRD information output from the speed control circuit 1043, to determine whether the cycle of the TZC signal is greater than a predetermined time Th1 (step S1803).

When the cycle of the TZC signal is smaller than the predetermined time Th1 (No in step S1803), the process returns again to step S1803. In other words, the process waits until the cycle of the TZC signal is greater than the predetermined time Th1.

When the cycle of the TZC signal is greater than the predetermined time Th1 (Yes in step S1803), the process then determines whether the cycle of the TZC signal is smaller than a predetermined time Th2 (step S1804).

When the cycle of the TZC signal is greater than the predetermined time Th2 (No in step S1804), the process returns again to step S1804. In other words, the process waits until the cycle of the TZC signal is smaller than the predetermined time Th2.

In other words, the operation from step S1803 to step S1804 is the operation of first waiting until the TZC cycle is greater than the predetermined time Th1, and then waiting until the TZC cycle is smaller than the predetermined time Th2. More specifically, as the TZC signal is obtained by binarizing the TE signal, the operation from step S1803 to step S1804 is the operation of first waiting until the zero crossing of the TE signal is slow, and then waiting until the zero crossing of the TE signal is fast. By appropriately setting the predetermined times Th1 and Th2, the operation from step S1803 to step S1804 can function as an operation of waiting for the eccentric fold to be detected.

In step S1804, when the cycle of the TZC signal is smaller than the predetermined time Th2 (Yes in Step 1804), the process sets the VCON signal to high. At the same time, the process indicates the inner peripheral direction as the direction in which the objective lens 1027 is driven according to the VCCTRL signal (step S1805).

In other words, in step S1805, the speed control is started with the assumption that the moving direction of the track at the time of step S1805 is the inner peripheral direction.

After step S1805, the system control circuit 1031 waits for a predetermined time T1s (step S1806).

After step S1806, the process determines whether the cycle of the TZC signal is greater than a predetermined time Th3 (step S1807).

When the assumption in step S1805 is correct (when the moving direction of the track at the time of step S1805 is the inner peripheral direction), the cycle of the TZC signal changes to the target cycle TGTPRD.

On the other hand, when the assumption in step S1805 is incorrect (when the moving direction of the track at the time of step S1805 is the outer peripheral direction), the cycle of the TZC signal decreases rapidly.

Thus, the operation of step S1806 and step S1807 functions as an operation of determining whether the assumption of the moving direction of the track is correct, by determining the time T1s from the response time of the speed control, and by appropriately setting the time Th3 to a time shorter than the target cycle TGTPRD. For example, the time Th3 can be set to half the target cycle TGTPRD.

In step S1807, when the cycle of the TZC signal is smaller than the predetermined time Th3 (No in step S1807), the process sets the VCON signal to low, and then stops the speed control (step S1808). After step S1808, the process returns to step S1803.

In step S1807, when the cycle of the TZC signal is greater than the predetermined time Th3 (Yes in step S1807), the process sets the LSCTRL signal to middle, and starts reducing the VLS amplitude (step S1809).

After step S1809, the process determines whether the LSOK signal is a high level (step S1810).

When the LSOK signal is not a high level (No in step S1810), the process returns again to step S1810. In other words, the process waits until the LSOK signal is set to a high level.

When the LSOK signal is a high level (Yes in step S1810), the process sets the LSCTRL signal to low, and resets the VLS voltage (step S1811). Then, the process sets the VCON signal to low, and then ends the speed control (step S1812).

After step S1812, the process sets the IRON signal to high, and turns on the tracking servo (step S1813).

Next, the process monitors the TROK signal to determine whether the TROK signal is set to high in a predetermined time (step S1814). When the TROK signal is set to high in the predetermined time (Yes in step S1814), the process determines that the track pull-in is successful, and ends the track pull-in process (step S1815).

When the TROK signal is not set to high in the predetermined time (No in step S1814), the process returns to step S1802 to retry the track pull-in process.

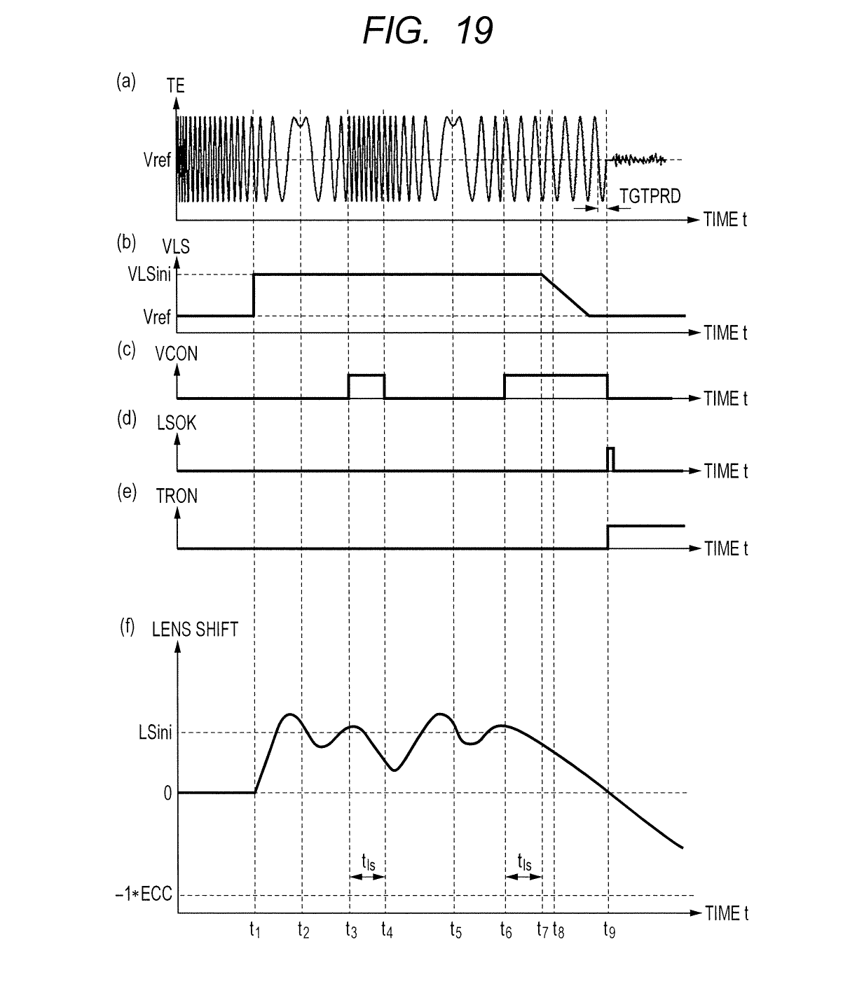

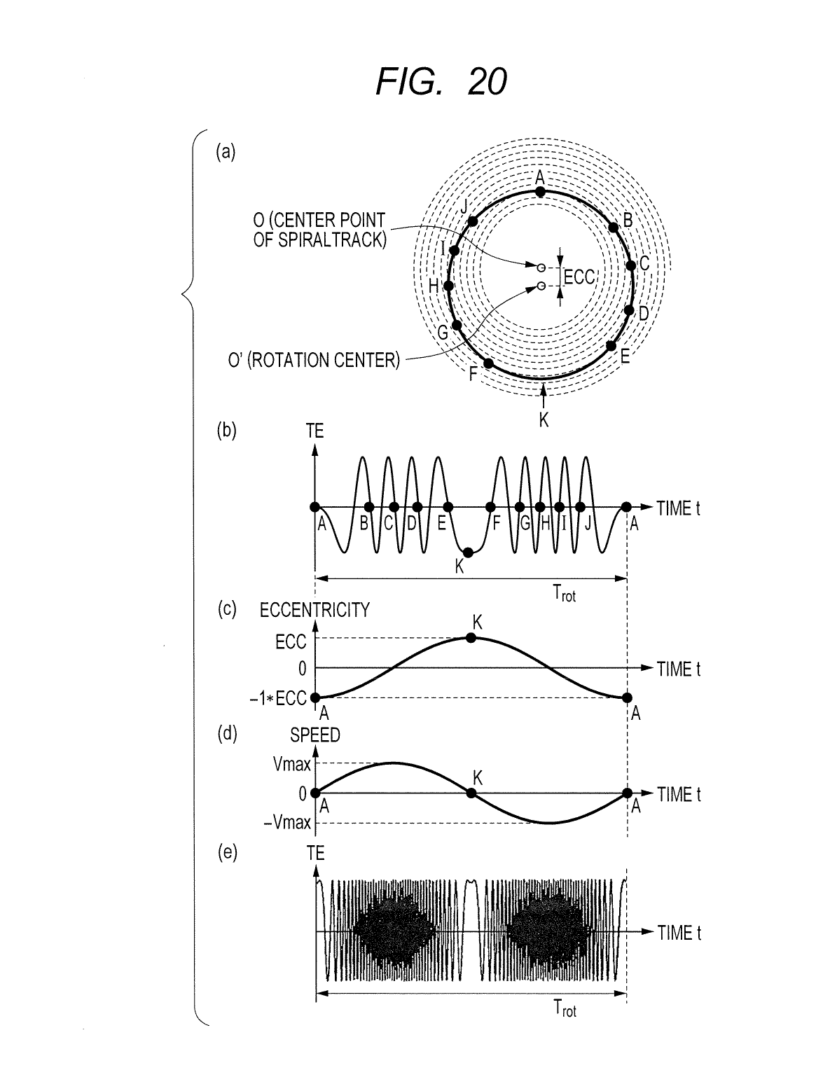

Next, the effect of this embodiment will be described with reference to FIG. 19.

FIG. 19 shows an example of various waveforms when the track pull-in process is performed. In FIG. 19, (a) shows the TE signal, (b) shows the VLS signal, (c) shows the VCON signal, (d) shows the LSOK signal, (e) shows the TRON signal, and (f) shows the lens shift of the objective lens 1027.

Time t1 is the start time of the track pull-in process. In FIG. 19, the moving direction of the track is omitted, but it is shown that the track moves in the inner peripheral direction at time t1. In this case, the track pull-in process according to this embodiment starts outputting the VLS voltage by setting VLSini to a voltage larger than Vref in FIG. 19(b).

As a result, in FIG. 19(f), the objective lens 1027 moves to the outer peripheral side and a lens shift occurs. In FIG. 19(f), LSini represents the lens shift at the position to which the objective lens finally moves when the voltage VLSini is given as the TRD signal. The objective lens 1027 vibrates and moves to the lens shift position LSini.

Time t2 is the time when the cycle of the TE signal is the maximum value, namely, when the eccentricity is the maximum value. At this time, the moving speed of the track is zero. The moving direction of the track is reversed after time t2. Then, the track moves in the outer peripheral direction.

In this embodiment, after time t1, the process monitors the TZC cycle, waits until the zero crossing of the TE signal is slow, and then waits until the zero crossing of the TE signal is fast.

Time t3 is the time when the two wait operations are completed (corresponding to the time determined as “Yes” for the first time in step S1804). In other words, at time t3, VCON is set to high in (c) and then the speed control is started.

Here, in this embodiment, different from the first and second embodiments, there is no way to determine the moving direction of the track. So the direction (the inner peripheral direction or the outer peripheral direction) in which the objective lens 1027 is driven, may not be set in the speed control.

Thus, in this embodiment, the lens is shifted to the outer peripheral direction at time t1. Further, at time t3, the speed control is performed by setting the drive direction of the objective lens 1027 to the inner peripheral direction with the assumption that the moving direction of the track is the inner peripheral direction. Then, the TZC cycle is measured after the predetermined time T1s has elapsed.

When the above assumption is correct, the relative speed decreases as a result of the speed control. The cycle of the TE signal approaches the target cycle TGTPRD. At the same time, the objective lens 1027 is driven in the inner peripheral direction from the position where the lens has been shifted to the outer peripheral direction. So, the LE signal changes to the neutral position where the lens shift is zero. At this time, the waveforms are the same as the waveforms described in the first embodiment shown in FIGS. 8 and 9.

FIG. 19 shows the case in which the assumption is incorrect. In other words, the track moves in the inner peripheral direction at time t1, so that the moving direction of the track at time t3 is reversed to the outer peripheral direction. However, the speed control is performed after time t3 with the assumption that the moving direction of the track is the inner peripheral direction.

In this case, the objective lens 1027 is driven in the opposite direction to the track. As a result, the relative speed increases, and the cycle of the TE signal decreases rapidly. Further, as the objective lens 1027 is driven in the inner peripheral direction, the LE signal changes to the neutral position where the lens shift is zero.

Time t4 is the time after the predetermined time t1s has elapsed from t3, which is the time when the TZC cycle is determined in step S1807. When the assumption of the moving direction of the track is correct, the TZC cycle must be a value close to the target cycle TGTPRD. Thus, in step S1807, threshold TH3 can be set to a value half the target cycle TGTPRD.

The cycle of the TE signal decreases at time t4, and the answer is No in step S1807. As a result, in FIG. 19(c), VCON=Low and the speed control is stopped.

After the speed control is stopped, the process monitors again the TZC cycle, waits until the zero crossing of the TE signal is slow, and then waits until the zero crossing of the TE signal is fast. During this time, the VLS voltage is output continuously. Thus, the objective lens 1027 vibrates and moves again to the lens shift position LSini.

Time t5 is the time when the cycle of the TE signal reaches the maximum again. After time t5, the track reverses the moving direction and starts moving in the inner peripheral direction.

After the speed control is stopped at time t4, the process monitors the TZC cycle, waits until the zero crossing of the TE signal is slow, and then waits until the zero crossing of the TE signal is fast

Time t6 is the time when the two wait operations are completed (corresponding to the time determined as “Yes” for the second time in step S1804). In other words, VCON is set to high at time t6 in FIG. 19(c), and the speed control is started again.

The moving direction of the track is reversed at time t2. In other words, the moving direction of the track at time t6 is the inner peripheral direction. The speed control is performed after time t6 with the assumption that the moving direction of the track is the inner peripheral direction.

Thus, the relative speed decreases as a result of the speed control. The cycle of the TE signal approaches the target cycle TGTPRD. At the same time, the objective lens 1027 is driven to the inner peripheral direction from the position where the lens has been shifted to the outer peripheral direction. As a result, the LE signal changes to the neutral position where the lens shift is zero.

As described above, in this embodiment, the process performs the speed control with the assumption that the moving direction of the track is the inner peripheral direction. If the assumption is incorrect, the process once stops the speed control, waits for the eccentric fold to be detected, and then performs again the speed control. In this way, if the assumption is incorrect, the speed control is performed one half cycle later in the state in which the moving direction of the track is the inner peripheral direction.

Time t7 is the time after the predetermined time t1s has elapsed from time t6, which is the time when the TZC cycle is determined again in step S1807.

The cycle of the TE signal at time t5 is close to the target cycle TGTPRD, and the answer is Yes in step S1807. As a result, the process starts reducing the VLS signal amplitude in FIG. 19(b).

Time t9 is the time when the lens shift is negative. At this time, as shown in FIG. 19(d), the LSOK signal is set to a high level. So the process sets the VCON to a low level and ends the speed control in FIG. 19(c). At the same time, the process sets TORM to high, and turns on the tracking servo. As a result, the track pull-in is successful with respect to the TE signal shown in FIG. 19(a).

As described above, in this embodiment, the process first shifts the objective lens 1027 to the outer peripheral direction, waits for the eccentric fold to be detected, and performs the speed control with the assumption that the moving direction of the track is the inner peripheral direction. Then, after the predetermined time T1s has elapsed, the process measures the TZC cycle to determine whether the assumption is correct. When the assumption is incorrect, the process waits for the eccentric fold to be detected again. On the other hand, when the assumption is correct as a result of the measurement of the TZC cycle, the process reduces the lens shift voltage, and turns on the tracking servo at the time when the lens shift is zero.

With the operation of the optical disk device according to this embodiment, it is possible to perform track pull-in at the time when the lens shift is zero even in the unrecorded area of the optical recording disk, and so it is possible to suppress the lens shift immediately after the track pull-in. Thus, with the optical disk device according to this embodiment, the influence of the visual filed characteristics can be reduced and the track pull-in performance can be improved.

Further, with the optical disk device according to this embodiment, the tracking servo is turned on at the time when the relative speed between the track and the objective lens is reduced by the speed control. Thus, the tracking pull-in performance can be improved.

In this embodiment, the process sets VLSini to a value larger than Vref, and determines the outer peripheral direction as the moving direction of the objective lens 1027, and determines the inner peripheral direction as the drive direction of the speed control. However, it is also possible to set VLSini to a value smaller than Vref. In this case, the process determines the inner peripheral direction as the moving direction of the objective lens 1027, and determines the outer peripheral direction as the drive direction of the speed con.

Further, in the above embodiment, the lens shift direction (the outer peripheral direction) of the objective lens 1027 and the drive direction of the speed control (the inner peripheral direction), which are determined based on VLSini as described above, are not changed by the retry. However, the present invention is not limited this embodiment.

For example, the retry process can be configured such that, as a result of the determination of whether the assumption of the moving direction of the track that is obtained by measuring the TZC cycle, when the assumption is incorrect, the lens shift direction of the objective lens 1027 is reversed based on VLSini. However, in such a case, the subsequent speed control should also be reversed to perform the speed control in the opposite direction to the direction in which the lens has been shifted.

In both cases, if it is possible to achieve the state in which the speed control is performed in the opposite direction to the direction in which the lens has been shifted, then the objective lens can be speed controlled in the direction in which the lens shift decreases.

With the optical disk device according to this embodiment, this state can be achieved even if the MIRRO signal is not output correctly.

Thus, even in the unrecorded area of the optical recording disk, the influence of the visual filed characteristics can be reduced and the track pull-in performance can be improved. Further, the tracking servo is turned on after the speed control is performed to reduce the relative speed between the track and the objective lens. Thus, the track pull-in performance can be improved.

With the operations described above, the optical disk device of the third embodiment can improve the track pull-in performance.

In the foregoing embodiments, the same track pull-in process is performed regardless of the eccentricity of the optical disk. However, it is also possible to perform the operations described in the embodiments only in the case in which the eccentricity ECC has been measured at the time when the optical disk is loaded, and when the eccentricity ECC is greater than a predetermined threshold.

The effect of this is a reduction in the time of the track pull-in process. Using the waveforms of the first embodiment shown in FIG. 8, the track pull-in process without using the present invention waits for the eccentricity fold before turning on the tracking servo at time t2. On the other hand, in the case of the present invention, the track pull-in process performs the speed control to drive the objective lens, and then turns on the tracking servo at time t5 when the objective lens reaches the neutral position where the lens shift is zero. Thus, the time of the track pull-in process is increased by the time from time t2 to time t5.

Here, both the first and second problems to be solved by the present invention are encountered when the optical disk has a large eccentricity. Thus, in the case of the optical disk with a small eccentricity, the time of the track pull-in process can be reduced by the configuration without using the present invention. As a result, for example, the seek time can be reduced.

On the other hand, if the present invention is not used for the optical disk with a large eccentricity, the track pull-in performance will be degraded. There is a possibility, for example, that the retry process will be repeated several times. In this case, the time of the track pull-in process is significantly increased. Thus, the present invention is applied only to the case in which the eccentricity is greater than the predetermined threshold. This makes it possible to improve the track pull-in performance and reduce the number of retry attempts. As a result, the time of the track pull-in process can be reduced.

Further, the track pull-in process described in the foregoing embodiments can also be applied to the track pull-in that is performed at the end of the seek operation. For example, in the rough seek operation for driving the slider in seeking to a different radial position, the track pull-in is performed after the end of the slider drive. When the address information is read from the optical disk by pulling in the track, the difference between the current address and the target address can be seen. Thus, the track pull-in process is necessary for the various seek operations. The present invention can also be applied to the track pull-in in these seek operations. In this way, it is possible to improve the track pull-in performance in the seek operations.

Furthermore, in the foregoing embodiments, the process waits for the eccentric fold and then starts the speed control. This is to increase the time for the process of the speed control as much as possible, by taking into account that the speed control should be stabilized until the lens shift is zero. As describe above, in order to perform the speed control, the moving direction of the track and the moving direction of the objective lens should be the same. For this reason, the speed control can be started at the point of the eccentricity fold.

In the foregoing embodiments, the process detects the time when the lens shift is zero based on the LSOK signal generated by the LE signal, and then turns on the tracking servo. However, the method of detecting the lens shift is not limited to this example. For example, it is possible to provide a sensor for measuring the displacement of the objective lens in the pickup. In this case, the lens shift can be detected independent of the LE signal generated by the reflected light from the optical disk.

In the foregoing embodiments, the process detects the time when the lens shift is zero, and then turns on the tracking servo. However, the time when the tracking servo is turned on may not be exactly the same as the time when the lens shift is zero. For example, it is also possible that the tracking servo is turned on at the time when the lens shift is in a predetermined range around zero. This is an example and can be achieved by detecting that the absolute value of the difference between the LE signal and the reference voltage Vref is less than a predetermined threshold. Also with this operation, the lens shift is approximately zero at the time when the tracking servo is turned on. As a result, the influence of the visual filed characteristics can be reduced and the track pull-in performance can be improved.

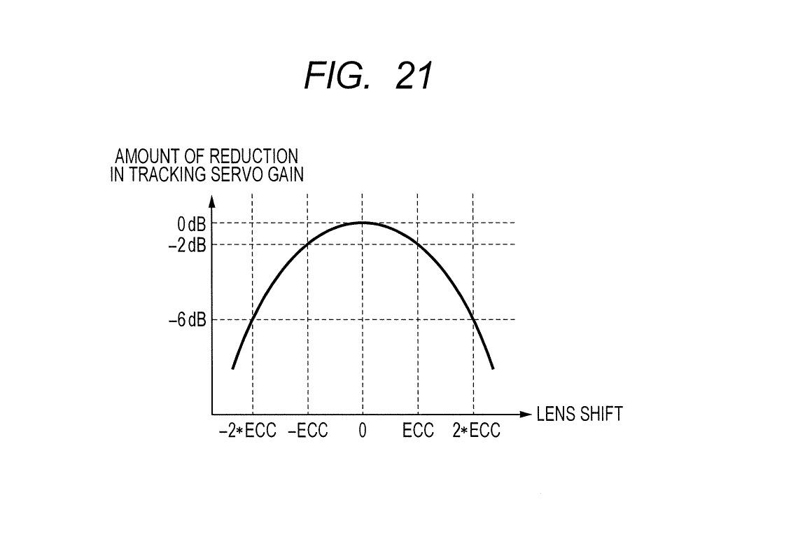

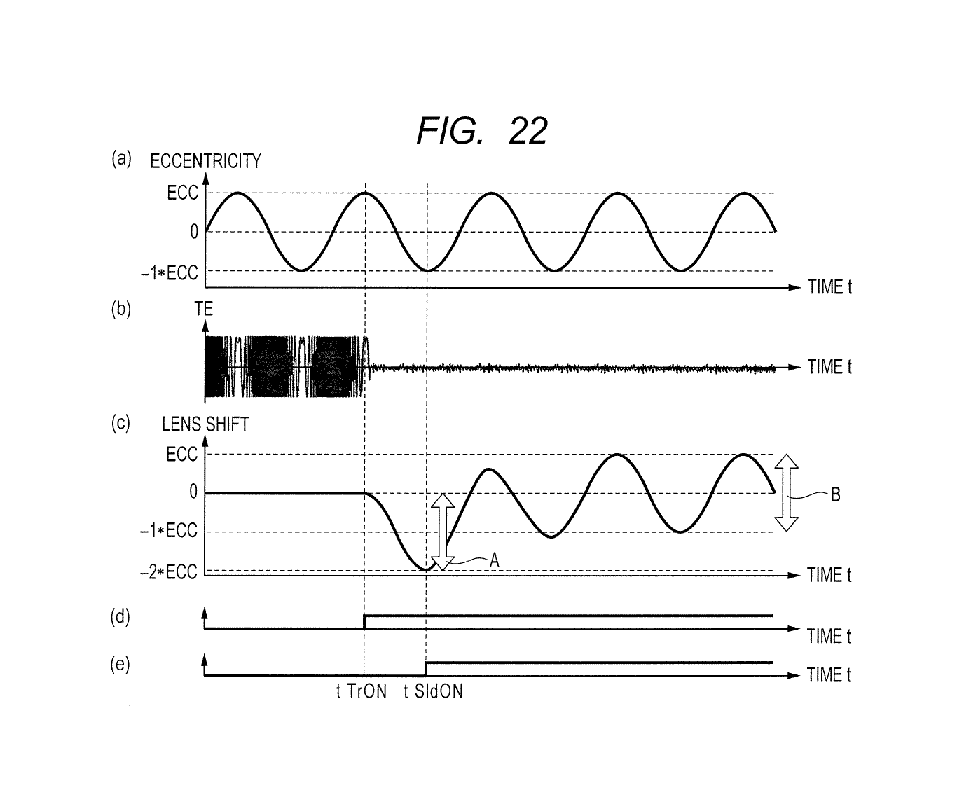

Further, in the foregoing embodiments, the process detects the time when the lens shift is zero, and then turns on the tracking servo. However, the time when the tracking servo is turned on may not be the same as the time when the lens shift is zero. The reason will be described below. FIG. 21 shows the visual field characteristics used for describing the foregoing embodiments. It is shown that the visual field characteristics are symmetrical about the position where the lens shift is zero. However, due to manufacturing error of the optical pickup or other reasons, the reference position where the visual filed characteristics are symmetrical may be displaced from the position where the lens shift is zero. In such a case, the lens shift position the least influenced by the visual field characteristics (called the optimal lens shift position) is not zero. Thus, in the various embodiments of the present invention, it is preferable that the time when the tracking servo is turned on is set to the time when the objective lens is the optimal lens shift position. This is an example and can be achieved by detecting the time when the LE signal passes across a predetermined threshold V_BestLS. Note that V_BestLS is the voltage level of the LE signal at the optimal lens shift position.

Still further, the present invention is not limited to the exemplary embodiments, and may include various modifications and alternative forms. For example, the forgoing descriptions of the specific embodiments are presented for purposes of illustration and description. They are not intended to be exhaustive or to limit the invention to the precise forms disclosed. Further, a part of the configuration of one embodiment can be replaced by the configurations of the other embodiments, or the configurations of the other embodiments can be added to the configuration of one embodiment. Further, the addition, deletion, and replacement of other configurations can be applied to a part of the configuration of each embodiment.

Still further, part or all of the individual configurations may be implemented by hardware or may be realized by the execution of a program by a processor. The control lines and the information lines are shown for illustrative purposes, and do not necessarily represent all of the control lines and information lines in terms of the product. In practice, it can be considered that nearly all the configurations are interconnected.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disk device for recording or reproducing information by irradiating a laser beam onto an optical disk, the optical disk device comprising:
an optical disk rotation unit for rotating the optical disk around a predetermined rotation axis;
an objective lens for focusing a light spot of the laser beam onto the optical disk;
an actuator for driving the objective lens;
an optical detector for outputting an electrical signal based on the amount of reflected light from the optical disk;
a focus error signal generation unit for generating a focus error signal from the output signal of the optical detector;
a tracking error signal generation unit for generating a tracking error signal from the output signal of the optical detector;
a focus control unit for performing focus control based on the focus error signal;
a tracking control unit for performing tracking control based on the tracking error signal;
a switch for controlling whether the output of the tracking control unit is supplied to the actuator;
a speed control unit for performing speed control to make the cycle of the tracking error signal substantially constant; and
a lens shift control unit for applying lens shift by moving the objective lens from the neutral position to the radial direction of the optical disk,
wherein after the speed control unit starts the speed control, the switch supplies the output of the tracking control unit to the actuator,
wherein before the speed control unit starts the speed control, the lens shift control unit applies the lens shift by moving the objective lens to the radial direction of the optical disk.

2. The optical disk device according to claim 1,
wherein the direction in which the lens shift control unit moves the objective lens to the radial direction of the optical disk, and the direction in which the objective lens is driven to the radial direction of the optical disk as a result of the subsequent speed control by the speed control unit, are opposite to each other.

3. The optical disk device according to claim 1,
wherein the optical disk device comprises a lens shift detector for detecting the position of the objective lens in the radial direction of the optical disk,
wherein the time when the switch supplies the output of the tracking control unit to the actuator, is the time when the lens shift detector detects that the objective lens approaches the neutral position.

4. The optical disk device according to claim 1,
wherein the optical disk device comprises a cycle measurement unit for measuring the cycle of the tracking error signal,
wherein the time when the speed control unit starts the speed control is the time when the cycle measurement unit detects that the cycle of the tracking error signal changes from increase to decrease.

5. The optical disk device according to claim 1,
wherein the speed control unit includes a speed control output variable gain for changing the gain of the output signal,
wherein after the lens shift control unit moves the objective lens to the radial direction of the optical disk, the speed control unit starts the speed control,
wherein the switch subsequently supplies the output of the tracking control unit to the actuator, to perform tracking pull-in operation,
wherein when the tracking pull-in operation failed, the speed control output variable gain is increased to perform again the tracking pull-in operation.

6. The optical disk device according to claim 1,
wherein the optical disk is a recordable optical disk,
wherein the optical disk device comprises a cycle measurement unit for measuring the cycle of the tracking error signal,
wherein after the lens shift control unit moves the objective lens to the radial direction of the optical disk, the speed control unit starts the speed control at the time when the cycle measurement unit detects that the cycle of the tracking error signal changes from increase to decrease,
wherein the switch subsequently supplies the output of the tracking control unit to the actuator, to perform track pull-in operation,
wherein when the track pull-in operation failed, the speed control unit waits until the cycle measurement unit detects that the cycle of the tracking error signal changes from increase to decrease, to start again the speed control,
wherein the switch subsequently supplies the output of the tracking control unit to the actuator, to perform the track pull-in operation.

7. The optical disk device according to claim 1,
wherein the optical disk device comprises an eccentricity measurement unit for measuring the eccentricity of the optical disk,
wherein when the eccentricity measured by the eccentricity measurement unit is greater than a predetermined threshold, the speed control unit starts the speed control after the lens shift control unit moves the objective lens to the radial direction of the optical disk,
wherein the switch subsequently supplies the output of the tracking control unit to the actuator.

8. A track pull-in method in an optical disk device for recording or reproducing information by irradiating a laser beam onto an optical disk,
wherein the method comprises the steps of:
rotating the optical disk around a predetermined rotation axis;
focusing a light spot of the laser beam onto the optical disk by an objective lens;
driving the objective lens by an actuator;
outputting an electrical signal according to the amount of reflected light from the optical disk;
generating a focus error signal and a tracking error signal, from the output electrical signal;
outputting a focus control signal based on the focus error signal, to drive the actuator in the rotation axis direction;
outputting a tracking control signal based on the tracking error signal, to drive the actuator in the radial direction of the optical disk;
controlling the speed of the actuator so that the cycle of the tracking error signal is kept substantially constant;
applying lens shift by moving the objective lens to the radial direction of the optical disk, before the start of the speed control; and
supplying the tracking control signal to the actuator after the start of the speed control, to perform track pull-in.

9. The track pull-in method according to claim 8,
wherein the direction in which the lens shift is applied by moving the objective lens to the radial direction of the optical disk, and the direction in which the objective lens is driven in the radial direction of the optical disk as a result of the subsequent speed control by the speed control unit, are opposite to each other.

10. The track pull-in method according to claim 8,
wherein the method includes detecting the position of the objective lens in the radial direction of the optical disk,
wherein the time when the tracking control signal is supplied to the actuator, is the time when the fact that the objective lens approaches the neutral position is detected in the detection step.

11. The track pull-in method according to claim 8,
wherein the method includes measuring the cycle of the tracking error signal,
wherein the time when the speed control is started, is the time when the fact that the cycle of the tracking error signal changes from increase to decrease is detected in the cycle measurement step.

12. The track pull-in method according to claim 8,
wherein the method includes the steps of:
applying lens shift by moving the objective lens to the radial direction of the optical disk, to start the speed control;
subsequently supplying the tracking control signal to the actuator, to perform track pull-in operation; and
when the track pull-in operation failed, increasing the gain of the output signal at the time of the start of the speed control, to perform again the track pull-in operation.

13. The track pull-in method according to claim 8
wherein the optical disk is a recordable optical disk,
wherein the method includes the steps of:
measuring the cycle of the tracking error signal;
applying lens shift by moving the objective lens to the radial direction of the optical disk;
starting the speed control at the time when the fact that the cycle of the tracking error signal changes from increase to decrease is detected in the cycle measurement step;
subsequently supplying the tracking control signal to the actuator, to perform track pull-in operation;
when the track pull-in operation failed, measuring again the cycle of the tracking error signal, to start the speed control after waiting for the time when the cycle measurement detects that the cycle of the tracking error signal changes from increase to decrease; and
subsequently supplying the tracking control signal to the actuator, to perform track pull-in operation.

14. The track pull-in method according to claim 8,
wherein the method includes the steps of:
measuring the eccentricity of the optical disk;
when the measured eccentricity is greater than a predetermined threshold, starting the speed control after applying lens shift by moving the objective lens to the radial direction of the optical disk; and
subsequently supplying the tracking control signal to the actuator.
